(19) United States
(12) Patent Application Publication
(10) Pub. No.: US 2025/0085607 A1
(43) Pub. Date: Mar. 13, 2025

(54) ON-CHIP PHOTONIC ULTRA-SHORT-PULSE SYNTHESIZER

(71) Applicant: California Institute of Technology, Pasadena, CA (US)

(72) Inventors: Ryoto Sekine, Pasadena, CA (US); Robert M. Gray, Pasadena, CA (US); Alireza Marandi, Pasadena, CA (US)

(73) Assignee: California Institute of Technology, Pasadena, CA (US)

(21) Appl. No.: 18/805,408

(22) Filed: Aug. 14, 2024

Related U.S. Application Data
(60) Provisional application No. 63/532,648, filed on Aug. 14, 2023.

(51) Int. Cl. G02F 1/365; G01N 21/31; G02F 1/39

(52) U.S. Cl. CPC G02F 1/365; G01N 21/3103; G02F 1/392

(57) ABSTRACT

An on-chip pulse synthesizer including an integrated photonic chip that temporally and spectrally shapes pulses of light using primarily quadratic optical nonlinearities. Through this synthesis, the light pulses undergo temporal shortening or reshaping, spectral broadening, wavelength conversion, or a combination thereof. A key aspect of this synthesis is the mode engineering of the waveguides, which includes converting the pump source mode to the relevant mode in the nonlinear optical region and tailoring the waveguide geometry and material stack to enable dispersion-engineering as well as engineering of the phase matching for various nonlinear processes.

### CROSS-REFERENCE TO RELATED APPLICATIONS

This application claims the benefit under 35 U.S.C. Section 119(e) of U.S. Provisional Application No. 63/532,648 filed Aug. 14, 2023, by Ryoto Sekine, Robert M. Gray, and Alireza Marandi, entitled “ON-CHIP ULTRA SHORT PULSE SYNTHESIZER,” (CIT-9055-P), which application is incorporated by reference herein.

This application is related to U.S. patent application Ser. No. 18/662,730, filed May 13, 2024, by Alireza Marandi, Luis. M. Ledezma, Arkadev Roy, Ryoto Sekine, and Robert M. Gray, entitled “THIN FILM SYNCHRONOUSLY PUMPED OPTICAL PARAMETRIC OSCILLATORS, which application claims the benefit under 35 U.S.C. Section 119(e) of:

U.S. Provisional Application No. 63/466,188 filed May 12, 2023, by Alireza Marandi, Luis. M. Ledezma, Arkadev Roy, Ryoto Sekine, and Robert M. Gray, entitled “THIN FILM SYNCHRONOUSLY PUMPED OPTICAL PARAMETRIC OSCILLATORS,” (CIT-9012-P); and

U.S. Provisional Application No. 63/532,648 filed Aug. 14, 2023, by Ryoto Sekine., Robert M. Gray, and Alireza Marandi, entitled “ON-CHIP ULTRA SHORT PULSE SYNTHESIZER,” (CIT-9055-P);

both of which applications are incorporated by reference herein.

### FEDERALLY SPONSORED RESEARCH AND DEVELOPMENT

This invention was made with government support under Grant No(s). FA9550-20-1-0040 and FA9550-23-1-0755 awarded by the Air Force, Grant No(s). W911NF-18-1-0285 and W911NF-23-1-0048 awarded by the US Army, Grant No. D23AP00158 awarded by DARPA, and Grant No(s). ECCS1846273 and CCF1918549 awarded by the National Science Foundation. The government has certain rights in the invention.

### BACKGROUND OF THE INVENTION

### Field of the Invention

This invention is related to pulse synthesis and method of and systems for implementing the same.

### Description of Related Art

This disclosure references a number of citations in brackets [x] which are listed at the end of the document

To date, the discrete and bulky nature of optical pulse synthesizer systems [1-4] as well as their power requirements and cost have inhibited their wealth of functionalities to be utilized for many wide-spread real-life applications [5]. Despite tremendous progress in nanophotonics, the prospect of fully integrated ultrafast optical circuits remains elusive as most of the well-established nanophotonic platforms do not natively include the most crucial capabilities such as proper dispersion engineering and strong controllable nonlinearity. While there has been significant progress towards generating multi-octave pulses on-chip [6], there has been little effort towards incorporating off-chip to on-chip mode converters or inverse taper type schemes to decrease the off-chip absolute power requirements to instigate these nonlinear processes, and especially not towards pulse synthesis. The present invention satisfies this need.

### SUMMARY OF THE INVENTION

This invention breaks these limitations and lays the foundation for pulse synthesis in integrated photonic chips, leveraging second-order nonlinearities. In one embodiment, an on-chip pulse synthesizer includes an integrated photonic chip that temporally and spectrally shapes pulses of light using primarily quadratic optical nonlinearities. Through this synthesis, the light pulses undergo temporal shortening or reshaping, spectral broadening, wavelength conversion, or a combination thereof. A key aspect of this synthesis is the mode engineering of the waveguides, which includes converting the pump source mode to the relevant mode in the nonlinear optical region and tailoring the waveguide geometry and material stack to enable dispersion-engineering as well as engineering of the phase matching for various nonlinear processes.

### BRIEF DESCRIPTION OF DRAWINGS

The patent or application file contains at least one drawing executed in color. Copies of this patent or patent application publication with color drawing(s) will be provided by the Office upon request and payment of the necessary fee

Referring now to the drawings in which like reference numbers represent corresponding parts throughout:

FIG. 1. Ultra-Short-Pulse Synthesizer. (a) depicts the main elements of the pulse synthesizer and (b) illustrates a particular example of the pulse synthesizer circuit. SSC: Spot size convertor, OPCPA: optical chirped pulse amplification. (c) Another embodiment of the ultra-short-pulse on-chip synthesizer, including a multi-octave OPO, cavity soliton, travelling-wave soliton, OPCPA, and IDFG.

FIG. 2. Packaged Chip. (a) shows a fiber coupled package whereas (b) illustrates a fully integrated package. These are mere examples and many variations of combinations including free-space, fiber coupled, butt-coupled, grating coupled, and monolithic/hybrid integrated options are available at both the input and output. MLL: mode locked laser.

FIG. 3. Pulse Input Coupler Designs. (a) example illustration combining a few different mode converting elements. (b) Schematic illustrating a spot size converter (c) Simulated effective index of modes as a function of bending radius for a typical nanophotonic waveguide structure. (d) Simulated effective index of modes as a function of waveguide top width for a typical nanophotonic waveguide implementation.

FIG. 4. Supercontinuum Generation Schemes in Quadratic Nonlinear Nanophotonics. (a)-(c) show various designs for SCG using the example of periodically poled nanophotonic lithium niobate, at pump wavelengths of 1, 1.55, and 2 μm, respectively. In each case (i) shows the dispersion given in the specific geometry and (ii) shows the simulated SCG using the same waveguide geometry. In (d) we show measured SCG out of a chip designed to have the dispersion profile in the proximity to that of (a), and in (e) we show a preliminary experimental spectra on the path towards implementing the device simulated in (c).

FIG. 5. f_{ceo} Detector. Example illustration. Similar results can be achieved using off-chip filters, dispersive elements, and detectors.

FIG. 6. IDFG. (a) Concept of IDFG on thin film lithium niobate on sapphire. (b) Dispersion parameters of nanophotonic PPLN as a function of waveguide top width and etch depth for a 950 nm thick film. (c) Idler wavelengths and necessary poling periods for IDFG between various wavelengths of the pump, where the blue lines indicate the pump center wavelength. (d) Frequency spectra and (e) time domain simulations of IDFG in a waveguide with 8 mm of 8 μm poling to generate a MIR frequency comb, using the single envelope approach described in [13], suggesting the potential of generating single-cycle mid-IR pulses in nanophotonic LN.

FIG. 7. Optical parametric chirped pulse amplification in thin-film lithium niobate. Optical parametric chirped pulse amplification in thin-film lithium niobate. a) Schematic of the designed nanophotonic circuit. b) Input signal pulse at 2.09 μm. c) Chirped input pulse after propagation through dispersion-engineered waveguide. d) Signal spectra at the input, after the pre-amplifier (intermediate), and at the output. e) Input pump pulses at 1.55 μm for the pre-amplifier (pump 1) and power amplifier (pump 2). f) Corresponding pump spectra. g) Recompressed output signal pulse enabling extreme nonlinear photonics.

FIG. 8. Bright-bright travelling-wave quadratic solitons. a) Fundamental and b) second harmonic soliton shapes for different values of α, found using Newton's Method. A comparison between the numerically found soliton amplitudes and approximate analytic solution for the c) fundamental and b) second harmonic shows good agreement. e) Real and f) imaginary parts of the funadamental soliton amplitude for fixed α=1.64 and varying δ. g) Range of parameters for which single-hump soliton solutions were found using numerical continuation. The solid line indicates the theoretical boundary of the existence range. h) Phase-space diagram for Δθ and u_{2ω} found using Lagrangian analysis, with the z axis indicating the pulse width parameter p. The soliton solution is indicated with a khacki circle. (i) Travelling-wave quadratic soliton formation can be utilized for sub-10-fs pulse synthesis in thin-film lithium niobate nanophotonics. a) Spectral evolution in the optical parametric amplification process, showing the onset of supercontinuum generation. j) Corresponding temporal evolution. k) Output spectrum after 5.5 mm of propagation. 1) Single-cycle pulses synthesized through separation and recombination of the fundamental and second harmonic outputs with five different relative phases.

FIG. 9. Theoretical scaling behaviors of quadratic soliton pulse compression. Simulated intensity evolutions of the fundamental wave with α=1.64 and a compression factor of 3 for a) α=a/10 and b) α=α/3 show the typical intensity evolution of the fundamental wave in quadratic pulse compression. The optimal compression point, ζₒₚₜ, is indicated. c) Scaling of ζₒₚₜ with the compression factor. The dashed line is a fit. d) Compression quality as a function of the compression factor. e) Full-width at half-maximum of the pulse at ζₒₚₜ compared to the soliton solution for the same parameters. f) Ratio of the peak value of | a_{2ω, opt}|², to that of | a_{2ω,in}|².

FIG. 10. Experimental demonstration of quadratic soliton pulse compression. a) Schematic of the experimental demonstration in nanophotonic LN. b) The input consists of a 40-fs pulse at the fundamental wavelength of 2090 nm. The outputs at the c) second harmonic and d) fundamental both exhibit ultra-fast features on the order of about 15 fs.

FIG. 11. Simulations of quadratic soliton pulse compression to the single-cycle regime. The input pulse profile in the a) time and b) frequency domains. c) The spectral evolution as a function of propagation distance in the nanophotonic crystal. d) The corresponding temporal evolution and its contributions from the e) fundamental and f) second harmonic waves. g) A single-cycle waveform of an approximately 3.5-fs duration is observed at the output, with both the h) fundamental and i) second-harmonic outputs both having a duration of approximately 7 fs.

FIG. 12. Pulse Compression via Higher Order Dispersion Engineering. Here, the blue and black lines denote second (fs²/mm) and third (fs³/mm) order dispersion at the signal wavelength respectively, and the red line denote the group velocity mismatch between the pump and signal.

FIG. 13. Nanophotonic pulse synthesis. a) One implementation of a nanophotonic pulse synthesizer, wherein an ultrashort input pulse is split into two or more spectral components whose phases are independently modulated before being recombined at the output. b) A second implementation, where a dispersive waveguide is used to temporally separate different spectral components whose phases may then be independently modulated before being recombined through a second dispersive element. As an example, we consider input electric fields at the c) fundamental and d) second-harmonic, which are taken from the output of the simulation of FIG. 11 e) Synthesized waveforms, obtained by varying the fundamental phase and recombining the two spectral components.

FIG. 14. Nonlinear waveguide Cross Section.

FIG. 15. Method of making a chip.

FIG. 16. Method of operating a chip.

FIG. 17. Soliton pulse compression in nanophotonic LN. (a) Experimental setup. (b) Simulations of the expected spectral broadening and (c) temporal compression as the pulse propagates through the waveguide. Following several back-and-forth conversions, the (d) fundamental at 143 THz and (e) second harmonic at 286 THz are both seen to compress and co-propagate. (f) The output spectrum and (g-i) temporal profiles for the simulated propagation demonstrate broadband supercontinuum generation and temporal widths as short 7 fs for the fundamental and second harmonic components and 3.5 fs for their combined output, indicating the potential for compression to the single-cycle regime. (j) Experimental FROG trace of the OPO output. (k) Example second-harmonic from chip, measured in an X-FROG geometry gated by the MLL output. MLL, mode-locked laser; OPO, optical parametric oscillator; FROG, frequency-resolved optical gating; Obj., reflective objective.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

This invention presents a fully integrated pulse synthesizer system. One of the main novelty aspects of this system is its focus on the design of ultrafast functionalities in second-order χ⁽²⁾ nonlinear nanophotonics through spatiotemporal confinement of light and accessing unprecedented levels of nonlinear interactions. These properties are instrumental for transforming the size and power requirements of ultrafast photonic systems, in stark contrast to the large body of existing designs based on cubic nonlinearities in other integrated photonic platforms. Additionally, this system allows access to extreme pulse synthesis, including few-optical-cycle operation and single-cycle synthesis, which can open unprecedented opportunities in nanophotonics while providing orders-of-magnitude reduction in the size and power requirements of ultrafast photonic systems. This advancement promises to revolutionize existing applications, including spectroscopy, communication, sensing, and unconventional computing. Furthermore, it can enable new applications such as on-chip attosecond physics, extreme nonlinear optics like high-harmonic generation extending to the extreme UV, and ultrafast quantum optics.

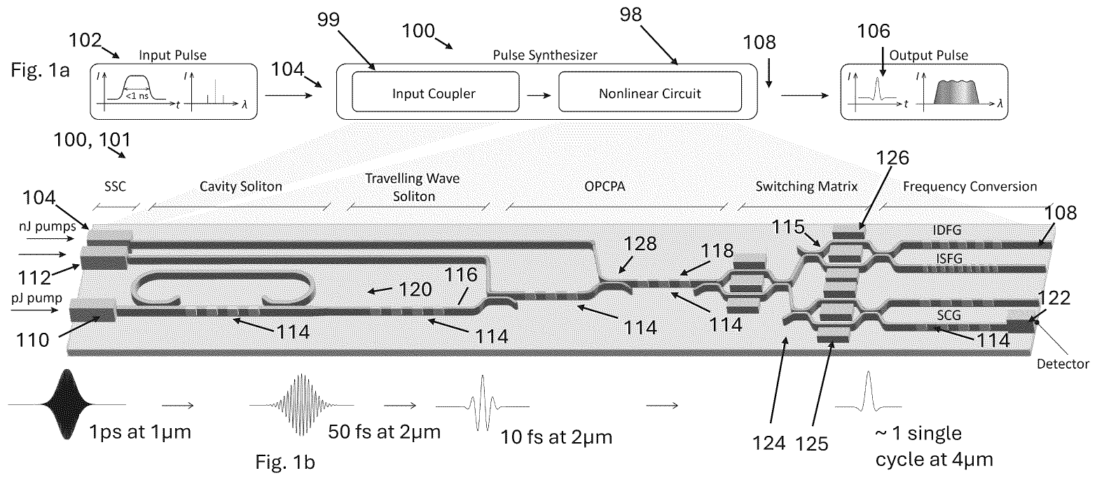

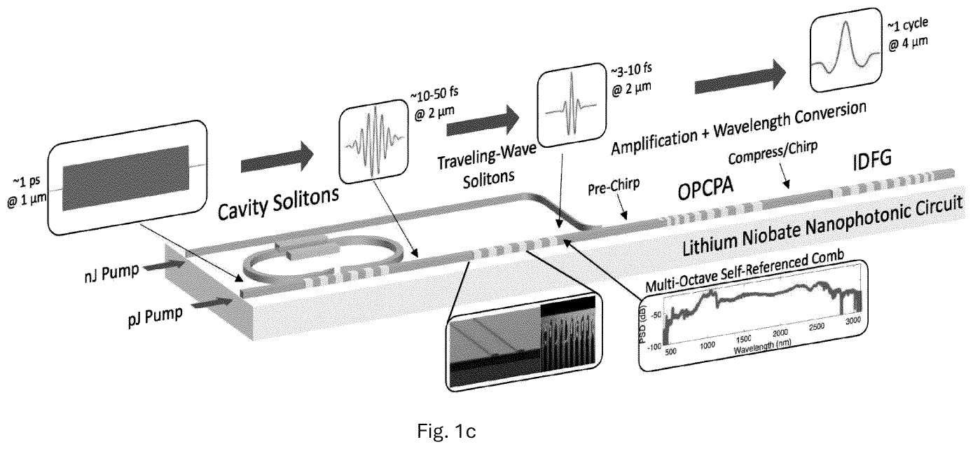

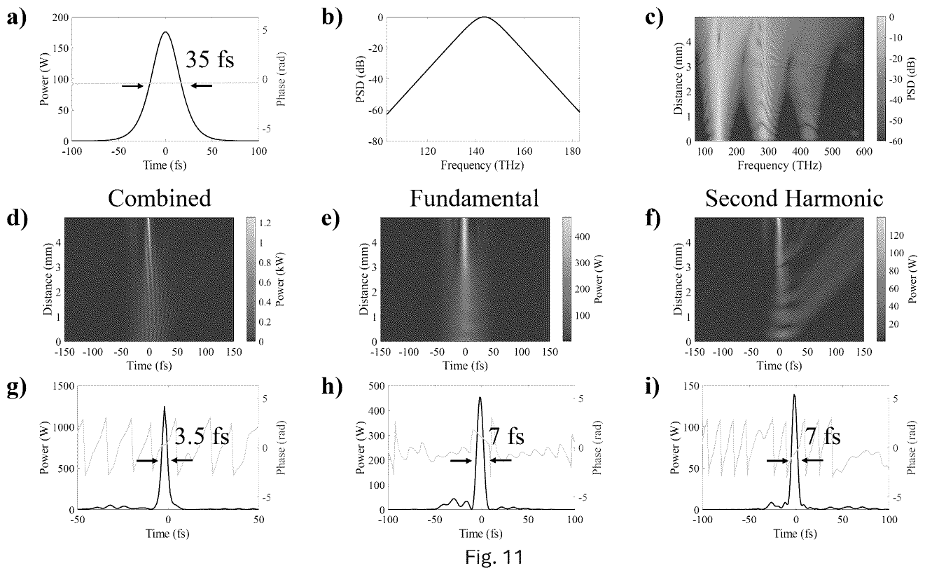

The present disclosure describes a pulse synthesizer that takes input pulses shorter than 1 ns and outputs temporally and/or spectrally shaped pulses using quadratic nonlinearity. As shown in FIG. 1 (a), the pulse synthesizer first converts the input beam/mode to the optimal one required in the region with second-order nonlinearity for pulse synthesis. The nonlinear synthesizer incorporates one or a plurality of nonlinear processes including, but not limited to, second harmonic generation (SHG), optical parametric amplification (OPA), supercontinuum generation (SCG), intra-pulse difference-frequency generation (IDFG), and intra-pulse sum-frequency generation (ISFG) as well as their inter-pulse variants. These processes can be further enhanced via resonators or soliton formation. FIG. 11(b), in fact, shows a specific example of synthesizing an ultrashort pulse by cascading a few of these nonlinear processes in a certain combination. Different combinations of these processes can also lead to different kinds of pulse synthesis, depending on the desired output pulse and application.

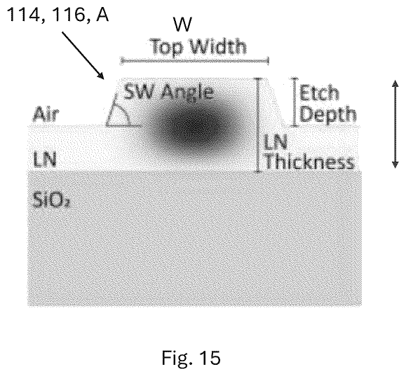

FIGS. 1-3 illustrate various embodiments of the integrated photonic chip 100 comprising a photonic integrated circuit 101 configured to accept input pulses 102 of electromagnetic radiation which are shorter than 1 ns at their full-width at half-maximum and generate pulses at one or multiple outputs 106 of the chip which have at least one of different spectral or temporal shapes than the input pulses. The circuit comprises a first input waveguide 110 comprising a first cross-section 112 to efficiently receive the input pulses from a free-space beam, an optical fiber, or another waveguide. The circuit further comprises a second waveguide 114 with a second cross-section 116 that supports an electromagnetic mode which has more than 90% of its energy confined in an area A (see FIG. 15) smaller than 5 microns by 5 microns that comprises second-order nonlinearity configured to modify the spectrum and/or the temporal shape of the input pulses, which involves generation new spectral content.

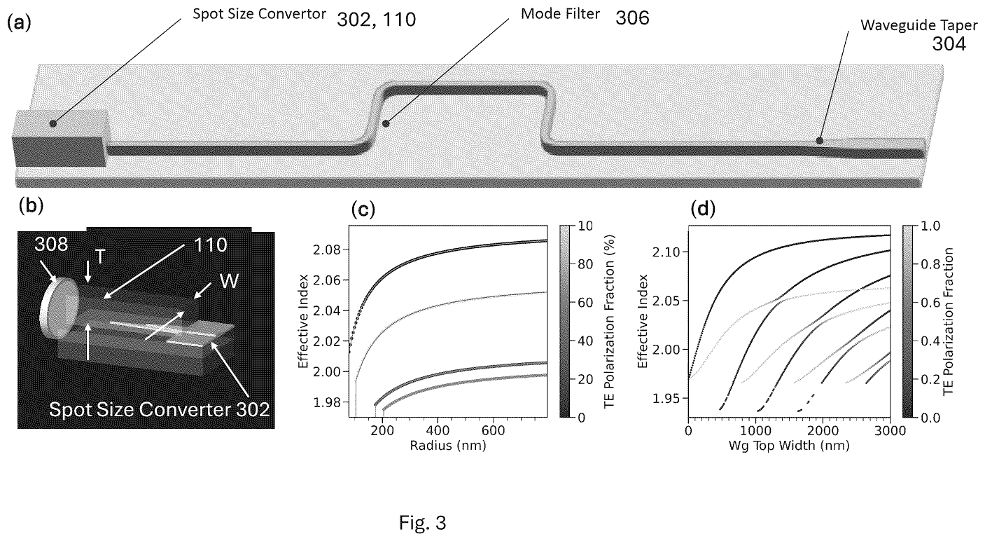

As illustrated in FIG. 3, the circuit further comprises at least one of a spot size converter 302, waveguide taper 304, inverse waveguide taper, or mode filter 306 (illustrated as a bend in the waveguide, although can also be a taper or an inversely designed structure, filter cavity (e.g., one or more rings or OPO) for example) configured for efficiently routing the radiation in one or a plurality of the modes of the first waveguide 110 to one or a plurality of modes in the second waveguide 114.

The first input waveguide 110 typically has a size and shape to match the size of the input pulse from off the chip and reduce its area down to the size of the second waveguide. FIG. 3b illustrates a particular example wherein the first input waveguide has a thickness T as close as possible to the beam cross-sectional size 208 of the input pulse and the spot size converter comprises a large lower index material large index ridge or channel waveguide along with a tapered structure of the material platform with nonlinearity that gradually changes dimension of the mode to couple into the dimension of the waveguides on the chip. In this way, the size of the mode of the input pulse received off chip (which is typically larger than the waveguides and not optimized to couple into the modes of the second waveguide) can be modified to match the cross-sectional area A (see FIG. 15) of the second waveguide which has been selected for appropriate dispersion engineering.

As illustrated in FIG. 1, the second waveguide 114 can comprise quasi-phase matching (for instance using periodic poling 118 with a single, multiple, or chirped poling periods) for one or a plurality of efficient nonlinear processes using the second order nonlinearity, such as second-harmonic generation, intra-pulse difference-frequency generation (IDFG), intra-pulse sum-frequency generation (ISFG), supercontinuum generation (SCG), optical parametric amplification (OPA) using the same input or an additional input as the pump, difference frequency generation involving an additional input, sum-frequency generation involving an additional input.

FIG. 1 further illustrates an example where in the second waveguide is coupled to one or a plurality of resonators 120, or the second waveguide is a part of a resonator 120, wherein the resonators provide resonance for at least part of the input spectrum or part of the generated spectrum.

FIG. 3 illustrates the first and/or the second waveguides may, in some embodiments, each comprise multiple waveguide geometries including, for example, a varying top width W in the range of 10 μm to 100 nm of the waveguide for dispersion engineering, phase matching, mode conversion, or mode filtering of the electromagnetic radiation.

FIG. 1b illustrates an example wherein the circuit further comprises an integrated photodetector 122 for receiving the output of the circuit and generating an electric signal associated with the CEO frequency of the input frequency comb.

FIG. 1b further illustrates an example wherein the second waveguide is configured for spectral broadening of the input, and the circuit further comprises components 124 to control the temporal shape of the output pulses by providing control over the phases of different spectral portion of the broadened output. In the example shown, the components 124 comprise phase actuators 125 on additional waveguides 115 that route the generated pulse to different nonlinearities (e.g., in different second waveguides 114) to manipulate it in different ways. The phase modulators can comprise, for example, of electrooptic modulators with electrodes 126 for applying a bias/electric field for modulating the refractive index of the additional waveguide 115 through the electrooptic effect, or heaters for applying heat to the waveguides for varying the refractive index through the thermo-optic effect

In other examples, the components 124 comprise a frequency-dependent splitter which splits the spectrum into two or more portions, each portion guided into different waveguides. Example frequency dependent splitters include, but are not limited to, adiabatic couplers, directional couplers, multi-mode interferometers (MMIs), Y-junctions, trident splitters, pulley couplers, star couplers, or arrayed waveguide gratings.

FIG. 1b further illustrates a frequency combiner 128 to combine different portion of the spectrum into one or a plurality of outputs which produces the temporally synthesized output pulses. Example frequency dependent splitters include, but are not limited to, adiabatic couplers, directional couplers, multi-mode interferometers (MMIs), Y-junctions, trident splitters, pulley couplers, star couplers, or arrayed waveguide gratings.

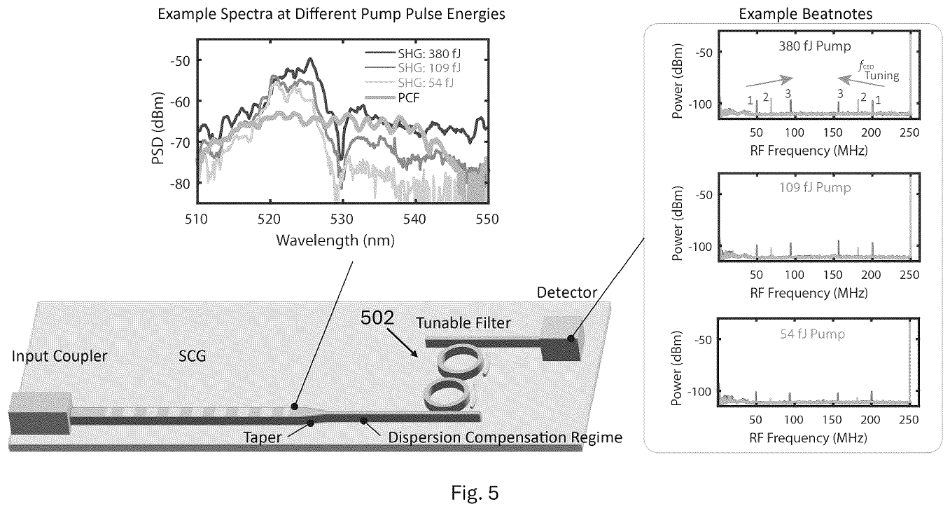

FIG. 5 further illustrates the photonic integrated circuit may comprise a tunable filter 502 before and/or after the second waveguide for selecting one or more frequency bins of the input and/or pulses. The filter 502 can comprise one or multiple electrooptic modulators or heaters tuning the refractive index of the waveguide (e.g., ring waveguides) at differing degrees and at differing speeds.

The photonic integrated circuit can be fabricated on a variety of platforms, e.g., lithium niobate thin film on substrates 130 including, but not limited to, silicon dioxide on silicon, silicon dioxide on bulk lithium niobate, quartz and sapphire, and wherein the nonlinear waveguide comprises periodic poling of the lithium niobate thin film. Other nonlinear materials can be used, however, including doped and un-doped variants of lithium niobate (LN) and lithium tantalate (LT), as well as graphene and III-V materials such as AlN, AlGaN, GaN, GaPN, InGaN, InPN, InN, AlP, AlGaP, AlInP, GaP, AlAs, GaInP, GaAs, InP, InGaP, AlSb, GaSb, InSb, InAs, and various phase matching schemes including quasi-phase matching, birefringent phase matching, and modal phase matching can be considered.

### Packaging

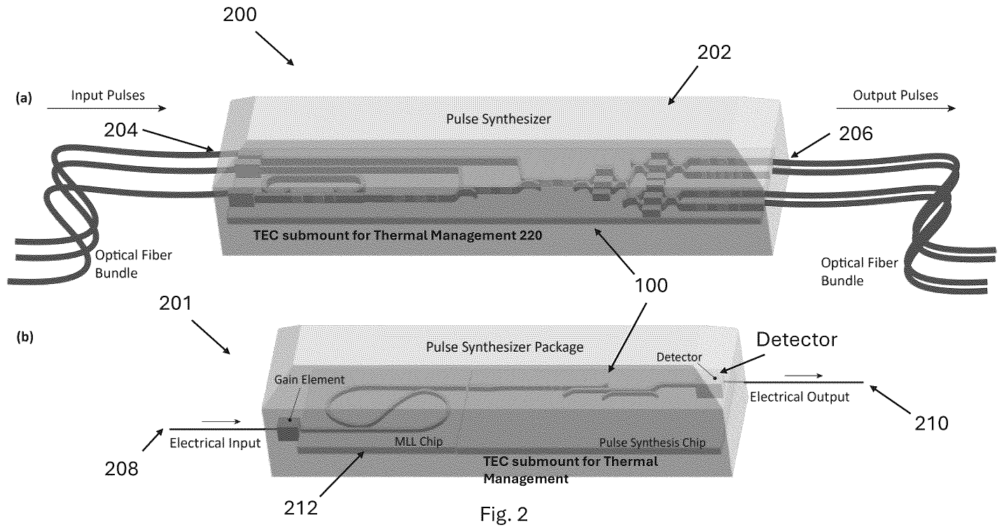

As shown in FIG. 2, this synthesizer unit can become a packaged module with various forms of inputs/outputs. In one embodiment illustrated in FIG. 2a, the packaged module 200 comprises the photonic integrated circuit 101 encapsulated in a protective package 202 (e.g., plastic epoxy resin); at least one optical input port 204 configured to receive optical signals; at least one optical output port 206 configured to output processed optical signals; and thermal management components (e.g., thermoelectric TEC submount 220)_integrated into the package.

FIG. 2b illustrates a packaged chip 201 with all electrical inputs 210 and electrical outputs 212, and further comprising a detector 122 and the photonic integrated chip 101 with chi(2) nonlinearity configured for synthesizing pulses of electromagnetic radiation by spectrally broadening and temporally shortening pulses inputted to the circuit. The packaged chip further comprises a MLL chip 212 comprising a mode locked laser (MLL) for outputting the input pulses provided to the synthesizer chip 101 via the input coupler (when the MLL chip is butt coupled to the synthesizer chip 101, for example). The electrical inputs provide the current for powering the MLL and the electrical outputs contain the signal from the detector.

Combinations of the two cases of the source either integrated in the same package or fed in/out externally are also possible. In the subsequent sections, we will describe the variations and design principles of both the input coupler and the nonlinear pulse synthesizer in further detail.

### Input Coupler

The input to the pulse synthesizer can take a myriad of forms. This includes but is not limited to, free space, fiber based (including lensed tip fibers), and integrated sources which are on a separate chip, hybrid-integrated, or monolithically grown on the same synthesizer chip. Through end-fire coupling, butt coupling, or grating coupling schemes, these pulses of light can be incorporated on the synthesizer chip. The spatial beam shapes of these pulsed sources is often different from those of the specific modes/dispersion profiles required for the nonlinear processes for pulse synthesis. Through a combination of mode converters, waveguide tapers, inverse tapers [10], spot size converters [11], grating couplers and mode filters [12], these pulses can be incorporated on-chip and converted to the optimal modes and waveguide geometries for pulse synthesis. An example of such a mode converter is shown in FIG. 3(a), with specific illustrations/design principles for a spot size convertor, bend mode filter, and regular taper illustrated in FIGS. 3 (b), (c), and (d), respectively.

### Nonlinear Circuit

The nonlinear elements of the circuit individually and collectively allow for pulse synthesis in the forms of temporal shortening and spectral shaping. The nonlinear processes include primarily second order nonlinear processes including SHG, OPA, SCG, IDFG, ISFG, that can be supplemented by direct or effective third and higher-order nonlinearities. The exact dispersion control now available in quadratic nonlinear media, can also sculpt the synthesis available in these nonlinear processes, and by combining with linear dispersive regimes, processes such as optical chirped pulse amplification (OPCPA) as well as other pulse synthesis schemes are described in this patent. Pulse synthesis can also be achieved via soliton and other nonlinear pattern formation as well as leverage enhancement through cavity effects. If the second-order nonlinearity is accessed via quasi-phase matching, aperiodic, chirped, and cascaded poling schemes can be employed to aid in synthesizing the pulse.

### SCG

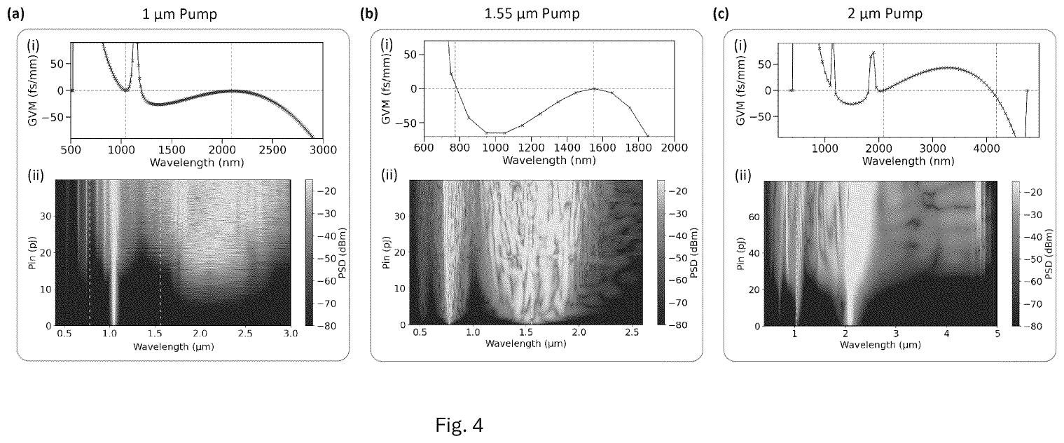

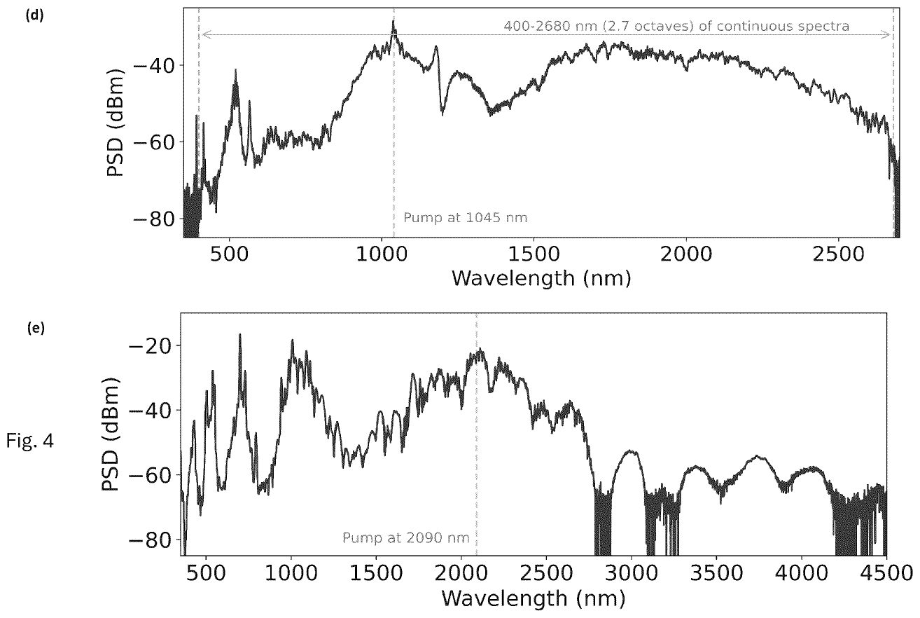

Unprecedented levels of supercontinuum generation at ultra-low pulse energies are now available in integrated photonics [7, 9]. This is partially due to quadratic nonlinearities being combined with the effects of dispersion engineering (a technique not available in previous generations of optics), quasi phase matching engineering [6], and tight mode confinement. In particular, it was found that operating in the near-zero dispersion regime where both the group velocity mismatch (GVM) between the pump and signal and group velocity dispersion (GVD) at both the pump and signal wavelengths are designed to be close to zero can result in multi-octave SCG [8, 9, 13]. Various implementations of this can be achieved using different pump wavelengths and waveguide geometries (including thin-film thickness, etch depth, top width, sidewall angle, cladding thickness, substrate material, cladding material, and nonlinear medium material). Examples of both simulated and measured SCG on the thin-film lithium niobate platform are shown in FIG. 4. In particular, FIGS. 4 (a) and (b) were simulated on thin film lithium niobate on a silica and silicon substrate, whereas (c) is the result of thin-film lithium niobate on a sapphire substrate. (d) is the measured result of operating in the regime close to (a), but with silica cladding, and (e) is the measured spectra out of a sapphire substrate device. The supercontinuum can be tuned via temperature, or the input pulse can be engineered via tunable filters at the input of the chip, or a tunable pulse source.

Such SCG is also typically the first step in pulse synthesis [14]. After coherent SCG, synthesis is achieved through adjusting the relative phases of the different spectral components generated continuum, as detailed in the following.

SCG can also be leveraged for the design of an integrated f_{ceo} detector, which is critical for many pulse-shaping applications. In particular, the SCG output may be spectrally split, with the long-wave components passed through a SHG process, and re-combined to achieve an f−2f beatnote. Such an f−2f signal, along with other self-referencing or cross-referencing techniques, are commonly used for monitoring as well as locking and tuning the f_{ceo} of combs [15]. Alternatively, the overlap between the fundamental and second harmonic signal can be filtered and sent on a detector as in FIG. 5, to act as a f_{ceo}. detector. while this particular illustration employs integrated filters and detectors, these can just as easily be implemented off-chip in free-space or fiber-based implementations. For example, we can use an off-chip detector with a free-space band-pass filter placed in front. Owing to the immense degree of freedom for dispersion engineering, by tailoring the waveguide geometry we can manage the pulse propagation after the SCG regime such that the fundamental and second harmonic regions of the generated pulse reach the detector at the same time. Note, this scheme can easily be extended or supplemented by other interferences including between the second harmonic and third harmonic (2f−3f), third-harmonic and fourth harmonic (3f−4f), fundamental and half-harmonic (f−f/2), or similar harmonic combinations.

This SCG can be used to cover multiple atomic, ionic, and molecular transitions and can be used for various spectroscopy schemes. There are many schemes that allow for both on-chip and even off-chip sensing schemes using such a source. Examples of the former include schemes that involve increasing the mode overlap outside of the waveguide via tailoring the waveguide geometry (including slot and suspended waveguides, and incorporating free space segments) as well as using resonators [16, 17. Furthermore, irrespective of sensing or the exact application, such broadband sources combined with tunable filters (both on or off-chip) can be used as an ultrabroad tunable source.

### IDFG

Synthesis and amplification of ultrashort optical pulses on chip open numerous opportunities for nonlinear optics and wavelength conversion. This goes far beyond the previous demonstrations of wavelength conversion in nanophotonic LN [18-20], which are not in the ultrashort pulse regime. The main motivation for wavelength conversion in this invention is to achieve intense optical pulses in a wide range of wavelengths enabling a plethora of on-chip ultrafast light-matter interactions. To this end, this invention contains up- and down-conversion of few-optical-cycle pulses, for which intrapulse difference frequency generation (IDFG) is one of the most exciting techniques, which has been used in free-space bulk optics to produce mid-infrared (mid-IR) frequency combs [21-23] but has not been accessible in nanophotonics yet.

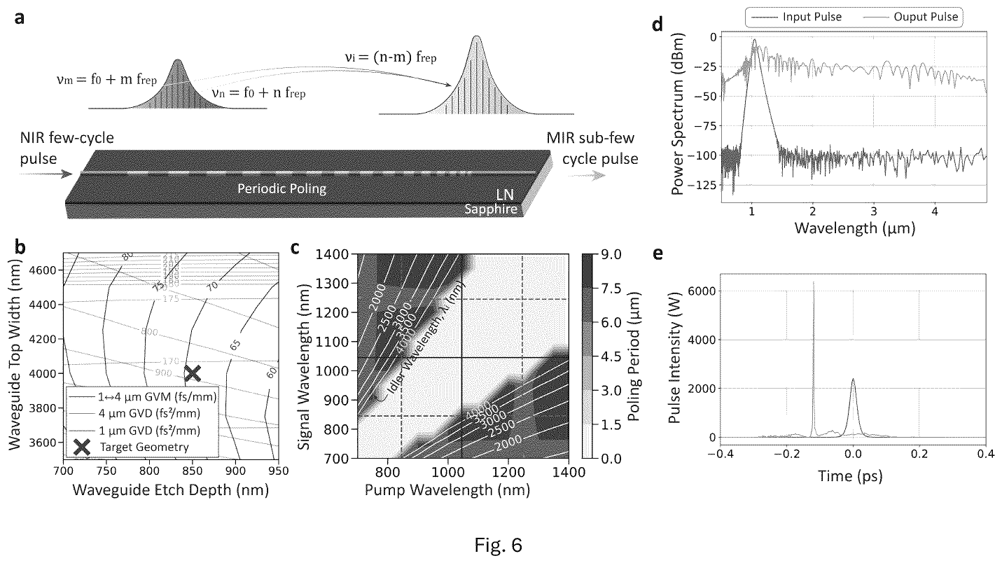

IDFG benefits from requiring few components, being intrinsically carrier-envelope phase (CEP) stable, and an ability to produce sub- to few-cycle output pulses. FIG. 6a illustrates a simple design of a nano-waveguide on LN for IDFG. Unlike typical optical parametric amplification (OPA), IDFG only requires one input frequency comb, and in contrast to optical parametric oscillators (OPOs), it only requires a single pass through a nonlinear element. There are inherent advantages of bringing IDFG to a nanophotonic platform. Not only will the smaller mode confinement allow for significantly lower pump pulse energies, but the ability to dispersion engineer enables significantly more control of the DFG pulse shape. Lower group velocity dispersion (GVD) at the output pulse wavelength keeps the generated pulse from widening, and control over the group velocity mismatch (GVM) between the signal and idler pulses enables us to shape the output idler pulse [24]. Combined, these capabilities not only unlock novel use cases for IDFG on an integrated platform, but may also allow us to observe new physics in extreme dispersion regimes. Significant amount of dispersion engineering in LN nanophotonics [13] makes it an ideal platform for IDFG.

In FIG. 6b we show how tuning waveguide parameters on a TFLN on sapphire substrate enables dispersion control between the 1 μm pump and 4 μm idler wavelengths in numerical simulation. The geometry indicated by the cross on the figure can support up to 4.8 μm modes, and as shown in FIG. 6c, by using various poling periods and pump wavelengths, a large range of mid-IR idler wavelengths can be generated. In FIG. 6d,e we show the simulated output spectra of an IDFG waveguide pumped with only 68 pJ of 25-fs pulses centered at 1 μm with a 250-MHz repetition rate. These simulation results suggest that single-cycle mid-IR optical pulses can be generated using IDFG in LN nanophotonics. Depending on the system requirements, more complicated dispersion engineering geometries, apodised periodic poling structures, and selection of waveguide material and structure may yield more suitable pulses.

### OPCPA

Inspired by the tremendous progress in the field of extreme nonlinear optics enabled by high-peak-power ultrashort pulse sources [25-27], this invention aims to enable a path to bring the wealth of such functionalities to the chip-scale. Apart from the capability to generate and synthesize ultrashort pulses, another important requirement for accessing such a regime of nonlinear optics is peak intensities on the order of 10¹² W/cm², which is typically achieved using chirped pulse amplification in bulky table-top systems. Here we describe our component that enables on-chip OPCPAs in LN nanophotonics towards such peak intensities.

A prominent example of extreme nonlinear optics is high-harmonic generation using ultrashort pulses, which allows entry to the extreme ultraviolet spectral region with attosecond pulse widths [27-30]. The resulting field of attosecond science offers many possibilities through the measurement and manipulation of matter at these ultrafast time scales [26, 31, 32]. Key to the generation of these high-power, ultrashort pulses has been the development of optical parametric chirped pulse amplification (OPCPA) [33]. OPCPA benefits from the high gains and large bandwidths that can be achieved in optical parametric amplification (OPA) utilizing quadratic nonlinearities as well as the concept of chirped pulse amplification which allows for the amplification of ultrashort pulses without exciting unwanted nonlinear processes. This is done through chirping of the pulses, causing temporal broadening which keeps the peak intensity low. However, such table-top OPCPA systems are bulky, complex, and power-hungry. Exploiting recent developments in lithium niobate nanophotonics, where OPA with high gain and a compact form factor have been demonstrated [13], to implement such OPCPA systems on a chip scale could greatly reduce their size, cost, and complexity for broad application. Furthermore, many properties of integrated platforms, including the ability to perform dispersion engineering and the tight spatial confinement, would be beneficial for engineering the chirp required for the OPCPA process and reducing the powers needed to achieve the necessary intensities for extreme nonlinear optics.

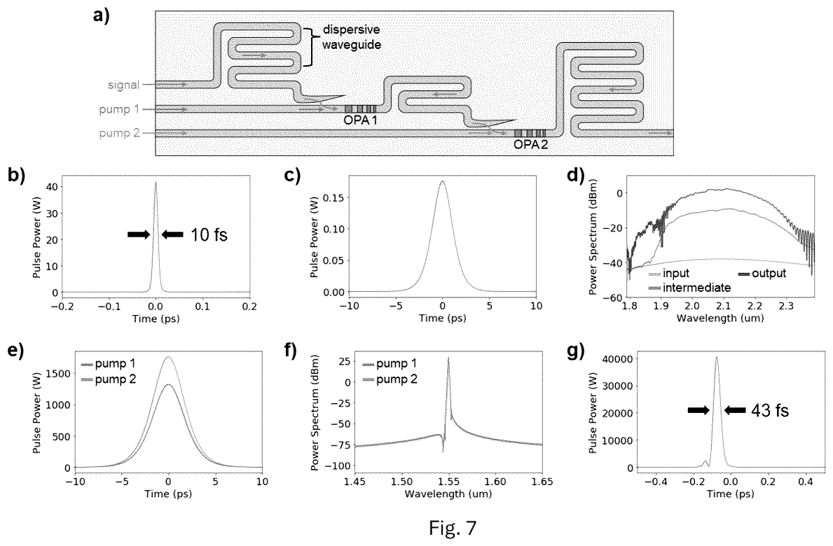

To validate that achieving such peak intensities is within reach in LN nanophotonics, we have performed numerical simulations as shown in FIG. 7. The designed photonic circuit, illustrated in FIG. 7a, resembles current state-of-the art systems in bulk, consisting of two aperiodically poled OPA stages in series [32], but it leverages the flexibility of dispersion engineering as well as the tight mode confinement offered by the nanophotonic platform. The waveguide for each OPA is taken to have a width of 2000 nm, a thin-film thickness of 715 nm, and an etch depth of 340 nm, resulting in a group velocity dispersion of 0.8 fs²/mm for the signal at 2090 nm and a group velocity mismatch between the pump at 1550 nm and the signal at 2090 nm of −15.6 fs/mm. The input signal pulse, shown in FIG. 7b, is a 10-fs, sech²-shaped pulse with a pulse energy of 500 fJ, which can be generated through quadratic soliton pulse compression, as discussed in a later section. The signal is then chirped using a low-loss, dispersive waveguide to a pulse width of 2.5 ps, as illustrated in FIG. 7a, and coupled into OPA 1 for pre-amplification. The corresponding spectrum of the input is shown in light pink in FIG. 7d. OPA 1 consists of a 20-mm aperiodically poled region designed for broadband phase matching between the pump at 1550 nm, signal at 2090 nm, and idler at 6000 nm. The 1550 nm pump pulses (pump 1) have a pulse width of 4 ps and a pulse energy of 6 nJ, with a temporal profile and spectrum as shown in FIG. 7e-f, respectively. The intermediate signal spectrum after pre-amplification is depicted in FIG. 7d. As can be seen through comparison with the input signal, the broadband signal gain from this first amplification stage is nearly 30 dB. Note that the idler mode is not well supported by the waveguide, which we have modeled through a 200 dB/cm loss imposed at the idler wavelengths.

The power amplifier stage, OPA 2, consists of a 10 mm poled region. As an input to this second amplification stage, the signal component of the preamplifier output is filtered out of the intermediate signal, further chirped, and then combined with a new pump (pump 2) consisting of 4-ps, 8-nJ pulses at 1550 nm, as shown in FIG. 7e-f The resulting signal spectrum can be seen in dark pink in FIG. 7d, indicating a broadband gain from the power amplifier stage of more than 10 dB. The resulting pulse may be recompressed using a waveguide engineered for dispersion compensation, resulting in a 43-fs pulse with a pulse energy of 1.93 nJ and a peak power of roughly 40 kW. Given a mode profile on the order of 1 μm², this suggests peak intensities sufficient to cross the 10¹² W/cm² threshold required for extreme nonlinear optics [25-27], and it is worth noting that further optimization may be performed on our OPCPA system with regards to the pump pulse widths and powers, signal pulse chirp, the waveguide geometry, and the poling design to push the output signal intensity even higher.

Many modifications to this geometry may be envisaged for the OPCPA module. Firstly, the dispersive and dispersion-compensation sections may be replaced by another integrated dispersive element, such as a Bragg grating or Bragg reflector. Furthermore, when possible, the pre-amplifier and power-amplifier may be simplified into a single amplification stage to reduce system complexity. Finally, in systems designed to support the idler mode, the OPCPA stage may additionally be used for wavelength conversion. Here, efficient conversion to the signal benefited from suppression of the idler due to the idler not being supported by a waveguide mode; suppression of either the signal or idler for such improved conversion can also be achieved through a spectrally selective loss mechanism such as a coupler or nano-antenna placed along the poled region.

### Travelling-Wave Soliton

The ability to perform ultrashort, and in particular few-cycle and single-cycle, pulse synthesis has become a hallmark of ultrafast lasers. Such sources have enabled field-resolved spectroscopic techniques[34], femtochemistry[35], extreme nonlinear optics, for instance for high-harmonic generation of UV light [27-30], and attosecond science and technologies [26, 31]. These exciting developments and functionalities have so far been exclusively in the territory of bulky table-top laser systems. This invention includes travelling-wave quadratic solitons as one of the foundations for realizing the first single-cycle synthesizer in nanophotonics.

Ultrashort pulse synthesis generally consists of supercontinuum generation, spectral splitting and phase shifting, followed by pulse compression [14], a combination that has been beyond the reach of a single nanophotonic platform. The use of soliton pulse compression, wherein the balancing effects of dispersion and nonlinearity allow for simultaneous spectral broadening and pulse shortening, enables the generation of ultrashort pulses in a single stage, greatly simplifying the system. Such soliton pulse compressors are ubiquitous in cubic nonlinear media [36-38].

Soliton pulse compression has also been studied in quadratic media and been used to generate few-cycle pulses [39, 40]. However, these prior demonstrations have exploited the so-called cascaded quadratic nonlinearity in a heavily phase-mismatched system, where the dynamics can be directly mapped to those of a cubic nonlinear system, to good approximation [41, 42]. Operation in this regime does not take full advantage of the plethora of co-propagating two-color quadratic solitons at the fundamental and second harmonic which may be realized in quadratic nonlinear systems [43-45], largely limited by the unavoidable presence of group velocity dispersion (GVM) in bulk nonlinear crystals [46]. Such constraints are reduced or removed altogether in dispersion-engineered nanophotonic systems, opening several unique possibilities for ultrashort pulse generation and synthesis leveraging the quadratic nonlinearity. In this invention, we include travelling-wave quadratic solitons which enable generation of few-cycle pulses on LN nanophotonic, for which the pulse compression can be achieved in a single dispersion-engineered waveguide. Theoretical description of two-color soliton formation begins with the coupled wave equations

[47]:

$$\frac{\partial {A}_{ω}}{\partial z} = - i κ {A}_{2 ω} {A}_{ω}^{*} {e}^{- i Δ kz} - \frac{i {β}_{ω}^{( 2 )}}{2} \frac{{\partial }^{2} {A}_{ω}}{\partial {t}^{2}} \qquad ( 1 a )$$

$$\frac{\partial {A}_{2 ω}}{\partial z} = - i κ {A}_{ω}^{2} {e}^{i Δ kz} - Δ {β}^{′} \frac{\partial {A}_{2 ω}}{\partial t} - \frac{i {β}_{2 ω}^{( 2 )}}{2} \frac{{\partial }^{2} {A}_{2 ω}}{\partial {t}^{2}} \qquad ( 1 b )$$

where A_{ω}(z, t) and A_{2ω}(z, t) represent the amplitudes of the fundamental and second harmonic waves at frequencies ω and 2ω, respectively, normalized such that the instantaneous power in each wave is given by |Aⱼ|², j∈{ω, 2ω}. The time coordinate is defined such that the reference frame is co-moving at the group velocity of the fundamental wave.

$$κ = \frac{\sqrt{2 {η}_{0}} ω {d}_{eff}}{{n}_{ω} \sqrt{{A}_{eff} {n}_{2 ω} c}}$$

is the nonlinear coupling coefficient, where d_{eff} is the effective nonlinearity, nⱼ is the refractive index of wave j, A_{eff} is the effective mode area, c is the speed of light, and η₀ is the impedance of free space. The group velocity mismatch is given by

$${Δβ}^{′} = \frac{1}{{v}_{g , 2 ω}} - \frac{1}{{v}_{g , ω}} ,$$

where v_{g,j} is the group velocity of wave j. Finally, βⱼ⁽²⁾ is the group velocity dispersion of the j^{th} wave. For the purposes of this analysis, we neglect higher dispersion orders.

The system may be simplified by considering the normalized waves a_{ω}=

$$\frac{\sqrt{2} κ}{β} \sqrt{\frac{{β}_{ω}^{( 2 )}}{{β}_{2 ω}^{( 2 )}}} {A}_{ω} {e}^{- i β z} and {a}_{2 ω} = - \frac{κ}{β} {A}_{2 ω} {e}^{- i ( 2 β + Δ k ) z} ,$$

where β accounts for shifts in the phase velocity induced by the nonlinear interaction. Additionally, we define a new spatial coordinate ζ=βz and a new temporal coordinate

$$ξ = \sqrt{- \frac{2 β}{{β}_{ω}^{( 2 )}}} .$$

Finally, defining

$$σ = \frac{{β}_{ω}^{( 2 )}}{{β}_{2 ω}^{( 2 )}} , δ = \frac{Δ {β}^{′}}{{β}_{2 ω}^{( 2 )}} \sqrt{- \frac{2 {β}_{ω}^{( 2 )}}{β}} , and α = σ ( 2 + \frac{Δ k}{β} ) ,$$

we may arrive at the following system of equations:

$$- i \frac{\partial {a}_{ω}}{\partial ζ} = \frac{{\partial }^{2} {a}_{ω}}{\partial {ξ}^{2}} - {a}_{ω} + {a}_{2 ω} {a}_{ω}^{*} \qquad ( 2 a )$$

$$- i σ \frac{\partial {a}_{2 ω}}{\partial ζ} = \frac{{\partial }^{2} {a}_{2 ω}}{\partial {ξ}^{2}} + i δ \frac{\partial {a}_{2 ω}}{\partial ξ} - α {a}_{2 ω} + \frac{{a}_{ω}^{2}}{2} \qquad ( 2 b )$$

Many families of bright-bright and bright-dark soliton solutions exist, depending on the relative signs of β and the dispersion parameters [45]. Here, we assume that

$$- \frac{2 β}{{β}_{ω}^{( 2 )}} > 0 ,$$

such that ξ is real, which will yield bright soliton solutions. Dark soliton solutions may be found when

$$- \frac{2 β}{{β}_{ω}^{( 2 )}} < 0 .$$

To find the soliton solutions, we begin by setting the spatial derivatives in equation (2) to 0. This gives the following set of equations:

$$0 = \frac{{\partial }^{2} {a}_{ω}}{\partial {ξ}^{2}} - {a}_{ω} + {a}_{2 ω} {a}_{ω}^{*} \qquad ( 3 a )$$

$$0 = \frac{{\partial }^{2} {a}_{2 ω}}{\partial {ξ}^{2}} + i δ \frac{\partial {a}_{2 ω}}{\partial ξ} - α {a}_{2 ω} + \frac{{a}_{ω}^{2}}{2} \qquad ( 3 b )$$

To begin our analysis, we will also consider δ=0. The cascading limit is given for α>>1, which is typically achieved through large phase-mismatch. By solving through an asymptotic expansion in the small parameter 1/α, one may find the first-order bright soliton solution:

$${a}_{ω} ( ξ ) = 2 \sqrt{α} sech ( ξ ) \qquad ( 4 a )$$

$${a}_{2 ω} ( ξ ) = 2 {sech}^{2} ( ξ ) \qquad ( 4 b )$$

To find solutions for general values of α we follow the variational approach of Sukhorukov [48], making the ansatz:

$${a}_{ω} ( ξ ) = {a}_{ω , 0} {sech}^{p} ( \frac{ξ}{τ} ) \qquad ( 5 a )$$

$${a}_{2 ω} ( ξ ) = {a}_{2 ω , 0} {sech}^{q} ( \frac{ξ}{τ} ) \qquad ( 5 b )$$

Solutions for the parameters a_{ω,0}, a_{2ω,0}, τ, p, and q may be found by plugging equation (5) into the system (3) with d=0. Equation (3a) is solved by setting q=2 and p=τ. Under these conditions, equation (3b) is only exactly solved with q=2 and α=1, yielding

$${a}_{ω , 0} = \sqrt{2} {a}_{2 ω , 0} = \frac{3}{2} ,$$

but the approximate behavior at the pulse peak and wings is well-captured by ensuring equation (5b) is solved at ξ→±∞ and ξ=0. One additional constraint may be obtained through recognition that system (3) with with δ=0 is a Hamiltonian system with a potential:

$$U = \frac{{a}_{ω}^{2} {a}_{2 ω}}{2} - \frac{1}{2} {a}_{ω}^{2} - \frac{1}{2} α {a}_{2 ω}^{2} \qquad ( 6 )$$

and a Hamiltonian:

$$H = \frac{1}{2} {( \frac{\partial {a}_{ω}}{\partial ξ} )}^{2} + \frac{1}{2} {( \frac{\partial {a}_{2 ω}}{\partial ξ} )}^{2} + U \qquad ( 7 )$$

For bright soliton solutions to this conservative Hamiltonian, we expect H=0 for all values of. Thus, the final constraint for ensuring correct behavior at the pulse peak is H|_{ξ=0}=U|_{ξ=0}=0. Taken together, this leads to the following set of equations for describing the scaling of the remaining parameters, p, a_{ω,0}, and a_{2ω,0}, at a given value of α:

$$p = \frac{1}{{a}_{2 ω , 0} - 1} \qquad ( 8 a )$$

$${a}_{ω , 0}^{2} = \frac{α {a}_{2 ω , 0}^{2}}{{a}_{2 ω , 0} - 1} \qquad ( 8 b )$$

$$α = \frac{{( {a}_{2 ω , 0} - 1 )}^{3}}{2 - {a}_{2 ω , 0}} \qquad ( 8 c )$$

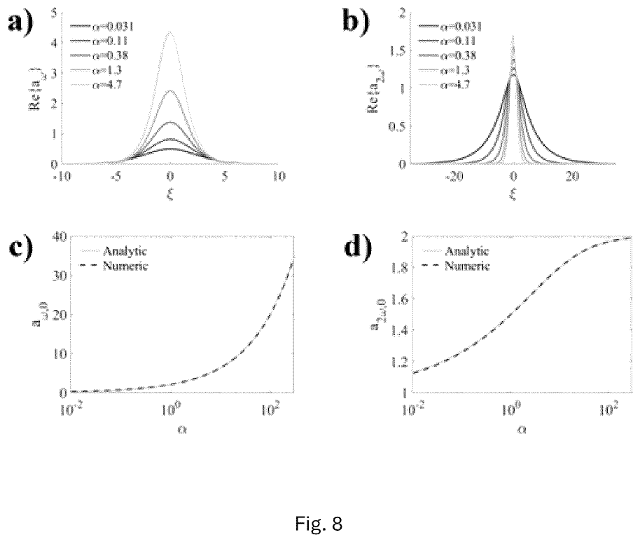

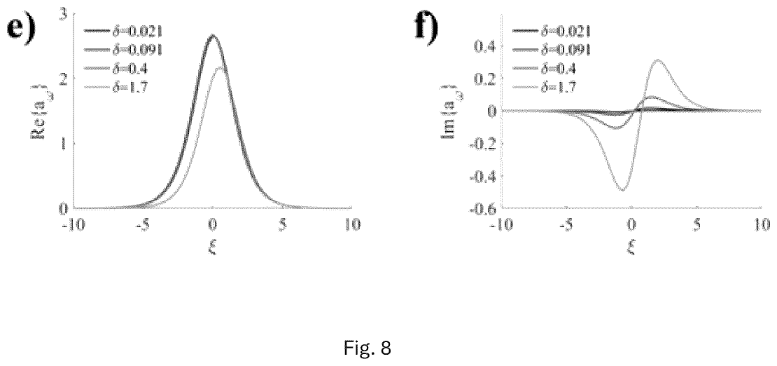

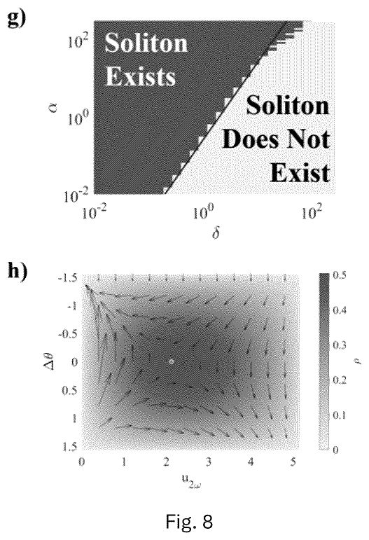

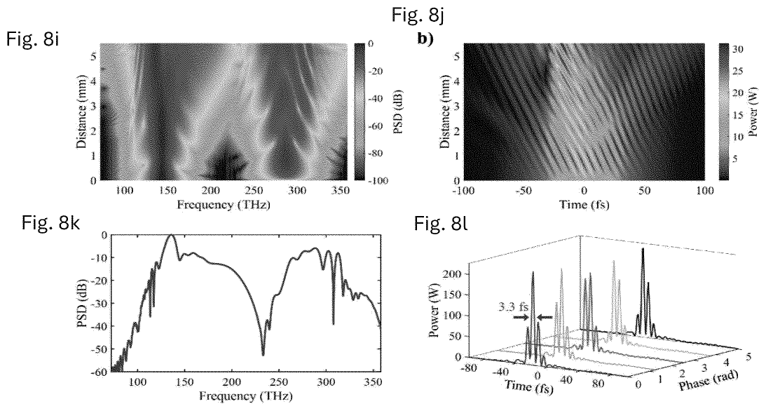

Using this variational solution as a seed, we may numerically find exact soliton solutions for arbitrary a using Newton's Method. The solutions for several values of α are given in FIG. 8a and FIG. 8b. One can see that at larger α, the soliton solution has a larger pulse amplitude and narrower pulse width in the normalized parameter. With α>>1, the amplitude of the fundamental wave is seen to be significantly larger than that of the second harmonic, whereas α<<1 results in the amplitude of the second harmonic being significantly larger than that of the fundamental. FIGS. 8-d show the amplitude scaling of the fundamental and second harmonic for different values of α for the numerical solution as well as the analytic solution, showing extremely good agreement.

We may additionally use Newton's Method to solve for the soliton solutions for δ≠0 through numerical continuation. An example of the resulting solution with α=1.64 is shown in FIGS. 8 e-f, where the real and imaginary parts of the fundamental soliton have been plotted. As can be observed, non-zero δ results in a growing imaginary component and asymmetry in the pulse amplitude; however, the solution does not deviate significantly from the δ=0 solution for sufficiently small values of δ. FIG. 8g shows the soliton existence range within the landscape of α and δ as found using numerical continuation. One may also find an analytic constraint for the soliton existence range by considering the solution of equation (3b) by direct integration [42]. Doing so yields the following solution:

$${a}_{2 ω} ( ξ ) = {\int }_{- ∞}^{∞} \frac{{a}_{ω}^{2} ( ξ - {ξ}^{′} )}{4 \sqrt{α - {δ}^{2} / 4}} {e}^{- i \frac{δ}{2}} {e}^{- \sqrt{a - {δ}^{2} / 4}} \vert {ξ}^{′} \vert d {ξ}^{′} \qquad ( 9 )$$

We may additionally use Newton's Method to solve for the soliton solutions for δ≠0 through From this, one may observe that a localized stationary solution is only obtained for

$$α > {( \frac{1}{2} δ )}^{2} .$$

This boundary is plotted as a solid line in FIG. 8 g and agrees well with the existence regime found via numerical continuation.

Finally, in the context of pulse compression, we are interested in the evolution of a non-solitonic pulse inside the waveguide. For this, we turn to Lagrangian analysis to find the evolution of the parameters of the key pulse parameters [49]. The Lagrangian density, L, for the system (2) with δ=0 can be written as:

$$L = σ Im \{ {a}_{2 ω}^{*} \frac{\partial {a}_{2 ω}}{\partial ζ} \} + Im \{ {a}_{ω}^{*} \frac{\partial {a}_{ω}}{\partial ζ} \} + {\vert \frac{\partial {a}_{ω}}{\partial ζ} \vert}^{2} + {\vert \frac{\partial {a}_{2 ω}}{\partial ζ} \vert}^{2} + {\vert {a}_{ω} \vert}^{2} + α {\vert {a}_{2 ω} \vert}^{2} - Re \{ {a}_{ω}^{2} {a}_{2 ω}^{*} \} \qquad ( 10 )$$

We may additionally use Newton's Method to solve for the soliton solutions for δ≠0 through We assume the following simplified functional forms for the fundamental and second harmonic based on the known exact soliton solution for α=1:

$${a}_{ω} ( ζ , ξ ) = {u}_{ω} ( ζ ) \sqrt{ρ ( ζ )} {sech}^{2} ( ρ ( ζ ) ξ ) {e}^{i \frac{{θ}_{ω} ( ζ )}{2}} \qquad ( 11 a )$$

$${a}_{2 ω} ( ζ , ξ ) = {u}_{2 ω} ( ζ ) \sqrt{ρ ( ζ )} {sech}^{2} ( ρ ( ζ ) ξ ) {e}^{i {θ}_{2 ω} ( ζ )} \qquad ( 11 b )$$

where u_{ω}, u_{2ω}, θ_{ω}, and θ_{2ω} are the fundamental and second harmonic pulse amplitudes and phases, respectively, and p is the pulse width parameter, assumed to be the same for both the fundamental and second harmonic. The time-averaged Lagrangian density, [symbol] , is then obtained inserting this ansatz into (10) and integrating over ξ.

$$ℒ = {\int }_{- ∞}^{∞} L ( ξ , ζ ) d ξ \qquad ( 12 )$$

Finally, the equations of motion for the system can then be found using the Euler-Lagrange equation,

$$\frac{\partial }{\partial ζ} ( \frac{\partial ℒ}{( \frac{\partial f}{\partial ζ} )} ) = \frac{\partial ℒ}{\partial f} ,$$

where f∈{p, θ_{ω}, θ_{2ω}, u_{ω}, u_{2ω}}. Steady-state solutions may be found by setting the resulting ζ derivatives to 0, yielding the following set of algebraic equations:

$$4 {ρ}^{3 / 2} ( {u}_{2 ω}^{2} + {u}_{ω}^{2} ) = {u}_{ω}^{2} {u}_{2 ω} \qquad ( 13 a )$$

$$2 + \frac{8}{5} {ρ}^{2} = \frac{8}{5} \sqrt{ρ} {u}_{2 ω} \qquad ( 13 b )$$

$$2 α + \frac{8}{5} {ρ}^{2} = \frac{4}{5} \sqrt{ρ} \frac{{u}_{ω}^{2}}{{u}_{2 ω}} \qquad ( 13 c )$$

In the case where α=1, the known soliton solution is recovered exactly. For other values of α, the steady-state solution can be seen to approximate the soliton solution. The dynamics of the system can be reduced to two algebraic equations and two differential equations as follows:

$${ρ}^{3 / 2} = \frac{1}{4} \frac{{u}_{2 ω} {u}_{ω}^{2}}{{u}_{2 ω}^{2} + {u}_{ω}^{2}} cos ( Δθ ) \qquad ( 14 a )$$

$$\frac{{u}_{ω}^{2}}{2} + σ {u}_{2 ω}^{2} = {η}_{tot} \qquad ( 14 b )$$

$$\frac{{du}_{2 ω}}{d ζ} = - \frac{2}{5 σ} \sqrt{ρ} {u}_{ω}^{2} sin ( Δθ ) \qquad ( 14 c )$$

$$\frac{d Δ θ}{d ζ} = - \frac{2}{5} ( \frac{{u}_{ω}^{2}}{σ {u}_{ω}} - 4 {u}_{2 ω} ) \sqrt{ρ} cos ( Δθ ) + \frac{4}{5} ( \frac{1}{σ} - 2 ) {ρ}^{2} + ( \frac{α}{σ} - 2 ) \qquad ( 14 d )$$

where we have re-parameterized the phase in terms of Δθ=θ_{ω}−θ_{2ω}. Equation (14b) is an energy conservation relation for the normalized system, with ηₜₒₜ being a constant representing the total energy of the system. To study the dynamics, we may first use the system (13) to compute the energy in the steady-state solution for a given value of α. Then, we may solve the dynamical system (14) for a given set of inputs. A typical phase-space diagram in the case of α=1 and σ=⅕ is shown in FIG. 8h, with the open khacki circle indicating the soliton solution. The background coloring depicts the value of pulse width parameter for the given values of u_{2ω} and Δθ. From this, we see that the soliton solution represents a saddle point in the system and also represents a near-maxima in ρ (corresponding to a minima in the pulse width). In a typical SHG soliton compression experiment, a pump pulse at the fundamental wave would initially generate a signal with

$$Δ θ = \frac{π}{2} ,$$

so the system would evolve towards the soliton solution from the bottom left until the optimum compression point was reached, after which the pulse width would again begin to increase.

To better quantify the exact scaling behaviors and determine some additional design principles, we turn to full simulation of the normalized coupled wave equations (2) using a fourth-order Runge-Kutta solver. We predominantly consider the case where δ=0, as we have observed previously that non-zero δ has limited impact on the soliton solution except near the edge of the existence regime, as δ approaches 2\sqrt{α}. The simulation is seeded by a sechshaped pulse at the fundamental which is taken to have a full-width at half-maximum (FWHM) that is C times larger than the FWHM of the soliton solution found using Newton's Method and a pulse energy equal to that of the combined fundamental and second harmonic solitons. We refer to the parameter C as the compression factor.

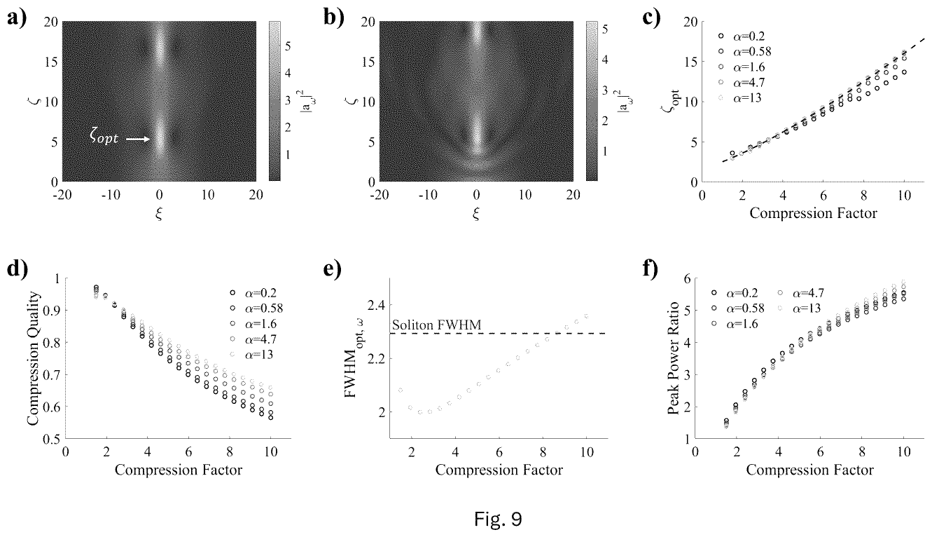

Two examples of the fundamental evolution in the crystal for α=1.64 and C are given in FIGS. 9a and 9b, with σ=α/10 and σ=α/3, respectively. The optimum compression point, ζₒₚₜ is considered to be the first local maxima of | a_{ω}|². For a given value of α, tuning σ predominantly changes the degree of phase matching, with σ=α/2 corresponding to a perfectly phase-matched case. This can be observed in the rate of the back-and-forth conversions between the fundamental and second-harmonic at small ζ, where | a_{ω}|² is seen to quickly oscillate as a function of ζ. Another interesting feature of the system which is not well-captured in the Lagrangian analysis is that the compression is cyclical in ζ, provided δ is sufficiently small.

For the remaining plots, a value of σ=α/10 is considered, as the key dynamics are observed to be largely independent of σ. FIG. 9c shows ζₒₚₜ as a function of the compression factor for different α values. Similar scaling behaviors are observed for all values of α, giving rise to the approximate design rule that ζₒₚₜ ≈1.7315+0.7785C¹.2639, which is the fit given by the dashed line. The compression quality, defined as the combined energy in the compressed fundamental and second-harmonic pulses divided by the input pulse energy [40], is shown in FIG. 9 d. A sech-shaped pulse is assumed for calculating the energy. As can be seen, the compression quality monotonically decreases with C, but a compression quality greater than 0.5 is still expected for C=10. FIG. 9 e shows the FWHM of the fundamental wave at ζₒₚₜ as a function of the compression factor for α=1.64. The FWHM is observed to dip even below that of the soliton solution, shown by the dashed line, for low values of C, with the shortest pulses occurring around a value of C=2.8. Finally, we plot the peak power ratio of the fundamental wave at ζₒₚₜ to that of the input for a variety of a values. Despite significant conversion to the second-harmonic wave, a similar peak power enhancement is observed for all values of α, and the enhancement increases monotonically with C, even up to C=10.

From this theoretical analysis emerges a variety of design considerations for optimizing quadratic soliton pulse compression systems. Firstly, one might consider how much of the output energy they would like to retain in the fundamental wave; larger values of α and smaller values of σ tends to favor energy retention in the fundamental wave. Secondarily, one must ensure that for the given value of α, a suitably low value of δ can be achieved for operation in the soliton regime. Once the desired values of α, σ, and δ are selected, one should pick a desired compression factor C, based on the observed trade-offs in the resultant compression quality, peak power ratio, and output FWHM. From there, ζₒₚₜ may be approximately calculated. Finally, given the FWHM of the soliton solution for the desired value of α, the input pulse width, and the desired compression factor, one may calculate the necessary values of β and β_{ω}⁽²⁾, where β can be calculated using conservation of energy through the normalization relations for the field amplitudes. If one is constrained in β_{ω}⁽²⁾, flexibility in pump pulse energy is required to achieve the necessary β, whereas the opposite is true if one is constrained in pump pulse energy. Knowledge of β and β_{ω}⁽²⁾ constrains the remaining design parameters, β_{2ω}⁽²⁾, Δβ′, and Δk, through their relations to α, δ, and σ.

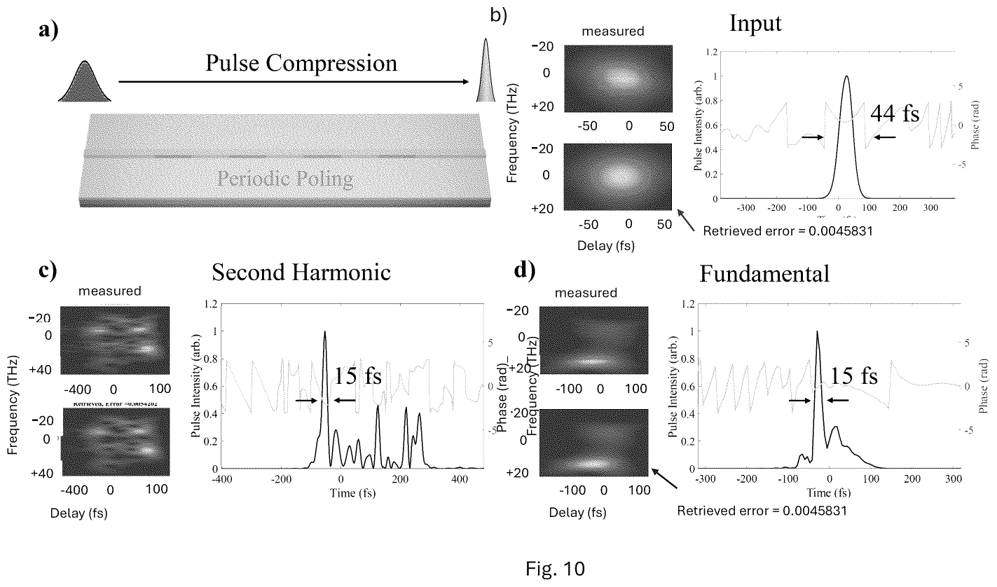

To demonstrate the potential of on-chip quadratic soliton compression for generating few- and even single-cycle pulses, we performed a proof-of-principle experiment in thin-film lithium niobate. A pump pulse at the fundamental wavelength of 2090 nm was sent through a dispersion-engineered, periodically-poled waveguide, shown in FIG. 10. The device had a thin-film thickness of 692.5 nm, a top width of 2520 nm, and an etch depth of 348 nm. This results in a GVD of 62 fs²/mm at the fundamental, a GVD of 135 fs²/mm at the second harmonic, and a GVM of 36 fs/mm between the two waves. The waveguide has a 6.5-mm periodically poled region for phase-mismatched SHG between the fundamental and second-harmonic waves.

A second-harmonic frequency-resolved optical gating measurement (FROG) is performed on the input wave, shown in FIG. 10b, which is measured to be 44 fs. Some chirp is observed, coming from the many optical elements traversed by the beam as it travels to the FROG apparatus; the transform-limited pulses width is estimated to be around 35 fs.

The pulses out of the chip were measured in an X-FROG geometry, wherein the pulses are gated through a sum frequency generation process by a high-power, 106-fs, near-transform-limited pulse from a mode-locked laser. The resulting reconstructed pulse intensities and FROG traces at the second harmonic and fundamental wavelengths are shown in FIGS. 10c and 10d, respectively. The FWHM of the output pulses is measured to be 15 fs in both cases, corresponding to an approximately factor of 2 pulse compression. This is just over 2 optical cycles at the fundamental wavelength of 2090 nm, demonstrating the potential of the on-chip soliton pulse compression system to generate few or even single-cycle pulses.

To confirm this potential for operating in the single-cycle regime, we perform numerical simulations based on the single-envelope equation. We consider propagation of a 7-pJ, 35-fs pump pulse at 2090 nm (or 143 THz), the temporal profile and spectrum of which are shown in FIGS. 11a and 11 b, propagating in a 5-mm-long periodically poled waveguide with similar dispersion parameters to the fabricated device. Here, the poling period is considered to be 40 nm larger than that required for perfect quasi-phase matching. The full spectral evolution along the crystal is illustrated in FIG. 114, showing the onset of supercontinuum generation. over the length of the crystal.

The corresponding temporal profile of the combined fundamental and second harmonic waves is shown in FIG. 11 d, while the independent evolutions of the fundamental and second harmonic waves are shown in FIGS. 11e-f As in the simulations of FIG. 9 based on the coupled wave equations, several back-and-forth conversions between the fundamental and second harmonic are observed to take place before the optimum soliton compression point is reached.

The output pulses at the end of the waveguide are shown in FIGS. 11g-i. The fundamental and second harmonic pulses both exhibit a FWHM of 7 fs, which is in the single-cycle regime for the fundamental, and their combined FWHM of 3.5 fs is also in the single-cycle regime for the combined carrier. Such a single-cycle pulse can be utilized directly as an ultrafast probe or taken as an input to a single-cycle pulse synthesizer.

### Resonant Enhancement

Incorporating a resonator with the aforementioned nonlinear processes and schemes can also lead to increased performance. For example, by including a zero-dispersion OPA/SCG in an OPO cavity, a multi-octave frequency comb can be generated with ultra-low (˜100 fJs level) pump pulse energies [9]. This particular scheme has been described in US provisional patent (63/466,188). For certain applications, it can potentially be sufficient to even have the cavity in free space [50] or fiber, as this level of dispersion control in the nonlinear regime is hitherto unprecedented.

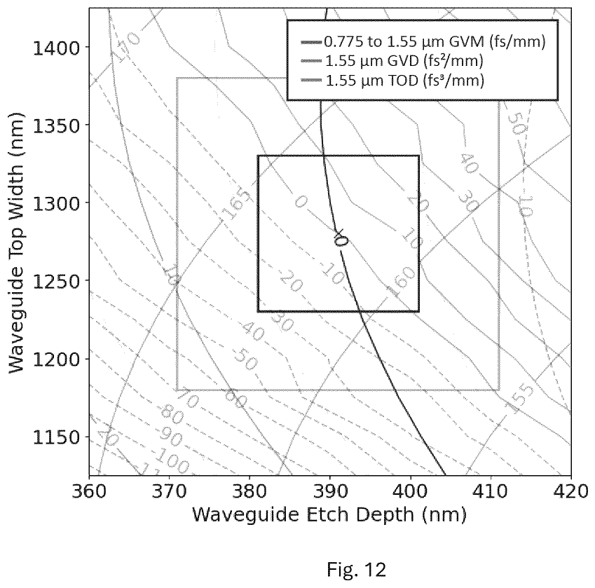

OPAs with significant walk-off (i.e. far from the aforementioned zero-dispersion regime) can also be pivotal for pulse synthesis. Cavity based pulse compression in the context of walk-off solitons was demonstrated in [51], and on-chip implementations have been further designed in U.S. patent application Ser. No. 18/662,730 filed May 13, 2024 and which claims priority to provisional patent (63/466,188). Here, we will add that these walk-off solitons can further benefit from control of even higher-orders of dispersion for even more pulse compression. For example, as shown in FIG. 12, it is possible to find regimes where the second and even third order dispersions are near-zero, meaning that the resulting pulse width will be dominated by fourth order dispersion of the waveguide.

### Pulse Synthesis

Following the generation of a short pulse or broad continuum, a pulse synthesizer allows for manipulation of the output waveform. Generally, this involves the separation and independent phase modulation of different spectral components of the waveform, followed by their recombination [14]. Here, we propose several possible architectures for on-chip synthesis of ultrashort pulses.

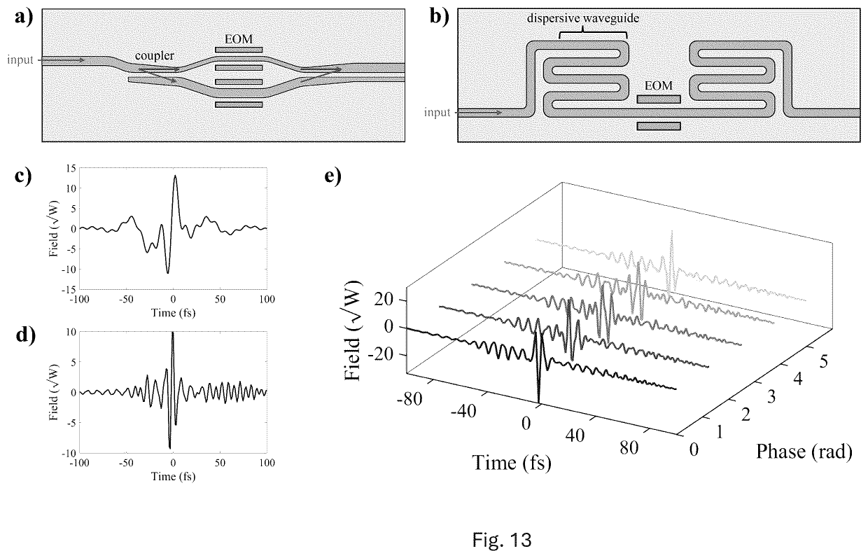

The first architecture is shown in FIG. 13a. Here, the input pulse is passed into a spectrally selective coupler which spatially separates the high and low frequency components. The different spectral components are then phase modulated using an electro-optic modulator (EOM) and re-combined at a second coupler, generating the desired pulse shape. Many modifications to this architecture can be envisaged, with the main one being the use of additional frequency channels to achieve additional control over the resultant pulse shape. Additionally, the EOMs may be replaced with other phase tuning mechanisms such as heaters; however, the use of fast EOMs (on the order of the repetition rate of the input pulse train) provides the additional advantage of enabling real-time control over the pulse profile.

The second approach is shown in FIG. 13b and takes advantage of the time-stretch dispersive Fourier transform to temporally separate different frequency components [52]. The input is first passed through a dispersive waveguide (or other dispersive element, such as a Bragg reflector). After being dispersed, and assuming the dominant contribution to the dispersion is second-order dispersion, the following mapping exists between the time trace and spectrum:

$$t = ( ω - {ω}_{0} ) {ϕ}_{2} \qquad ( 15 )$$

where t is fast time, ω is frequency, ω₀ is the carrier frequency, and ϕ₂ is the group-delay dispersion. For the dispersive waveguide, ϕ₂=β₂*L, where β₂ is the GVD at the carrier and L is the length of the waveguide section. The resulting temporally separated spectral channels are then passed through an EOM, which modulates the phase of the different spectral components. For a modulator with a bandwidth BW_{mod} (and corresponding minimum oscillation period

$${T}_{mod} = \frac{1}{B {W}_{mod}} ) ,$$

then, the frequency resolution achieved by

$$\frac{{T}_{mod}}{{ϕ}_{2}} .$$

For achievable modulation speeds in the 10 s of GHz, THz resolution can be achieved with ϕ₂ on the order of 10 s of ps². The ultimate limit to the number of channels for a system using this approach is given by the ratio of the spectral bandwidth, BW_{spec} to the pump repetition period Tᵣₑₚ. Specifically, the largest ϕ₂ which can be used without merging subsequent pulses is

$${ϕ}_{2 , max} = \frac{{T}_{rep}}{B {W}_{spec}} .$$

Thus, for an optimally designed system, the number of spectral channels which can be achieved is

$$\frac{{T}_{mod}}{{T}_{rep}} .$$

Following this spectral shaping in the time domain, a second dispersive element with an opposite dispersion sign is used to compensate the originally applied dispersion. To achieve additional spectral channels, one may combine this approach with the spatial approach of FIG. 13a by adding dispersive sections to each spatially separated channel. One additional possible modification to the system would be to replace the input and output dispersive sections with an appropriate time-lens system [53].

As an example of the functionality of the nanophotonic pulse synthesizer, we simulate the behavior of the architecture shown in FIG. 13a. For the input, we use the simulated single-cycle pulses generated by the travelling-wave soliton pulse compression shown in FIG. 11. The real parts of the electric field of the fundamental and second harmonic are shown, respectively, in FIGS. 13a-d. As discussed previously, the fundamental component is single-cycle, while the second harmonic component spans two cycles. FIG. 13e, demonstrates the different waveforms that may be synthesized through application of a relative phase ϕ on the fundamental wave and subsequent re-combination. The applied phase is swept from 0 to 2π. In such a 2-channel configuration, the synthesizer works essentially as a carrier-envelope offset phase shifter. Additional waveforms may be realized through the introduction of more spectral channels.

### Process Steps

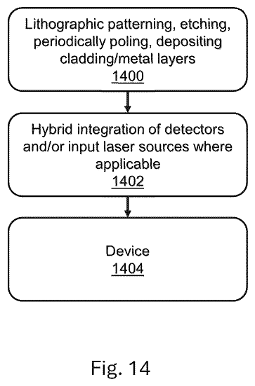

FIG. 14 is a flowchart illustrating a method of making a device according to one or more embodiments.

Block 1400 represents using lithographic patterning of a substrate combined with etching, periodically poling, and depositing of cladding layers and metals to form a photonic integrated circuit comprising the input coupler and the nonlinear waveguides as described herein. The nonlinear waveguides use second order nonlinear processes to convert a pump pulse into a signal and/or idler pulse.

Short (sub nanosecond) pulses typically contain smaller energies in the nanojoule and picojoule range. The waveguides are typically patterned with relatively small (micron or nanoscale cross-sections) to enhance the intensity of the pulses, and thereby increase the efficiency of the second order nonlinear process. FIG. 15 illustrates a typical example of a cross-sectional area, wherein the top width W of the cross-section of the waveguide is less than 3 microns, and the height H of the cross-section of the waveguides (thin film thickness plus etch depth) is less than 1 micron (e.g., in a range of 50-500 nm).

The nonlinear materials in the waveguides are dispersion engineered to control appropriate group velocity dispersion (GVD) of, and group velocity mismatch (GVM) between, pump and signal/idler pulses so as to control temporal overlap/walk off of the pump and signal/idler pulses. The dispersion engineering (GVD and GVM) is controlled by tailoring the size of the cross sectional area and/or top width of the waveguides. In some supercontinuum generation embodiments, GVM and GVD are both ideally zero. In some soliton generation embodiments, GVD and GVM may be controlled to provide a temporal mismatch between pump and idler/signal pulses which can be advantageous to make photonic states that better compress.

Quasi-phase matching of the nonlinear waveguides can be selected for a variety of nonlinear processes. The poling enables phase matching for some frequency components but not others, and the target frequency components can be engineered for example via chirped poling. The pulses can be chirped in the nonlinear waveguide prior to amplification in the waveguide and then de-chirped after amplification.

With or without cladding layers, actuators (e.g., electro-optic modulator, an electric heater, a thermo-optical heater, or a piezoelectric transducer, e.g., to modulate phase or amplitude of waves or refractive index of the using electric field or temperature) can be fabricated by depositing metallization coupled to the waveguides formed in the chip.

Block 1402 represents hybrid integration of other components such as detectors or pump lasers if the chip calls for this.

Block 1404 represents the end result, a pulse synthesizer.

The device can be embodied in many ways including, but not limited to, the following (referring also to FIGS. 1-17).
1. An integrated photonic chip 100 comprising a photonic integrated circuit 101 comprising:
   an input coupler 99 comprising a first waveguide 110 comprising a first cross-section 112 capable of receiving, or configured to or operable to (e.g., efficiently) receive input pulses 102 from a free-space beam, optical fiber, or another waveguide;
   at least one second waveguide 114 comprising a nonlinear waveguide with a second cross-section 116 that supports an electromagnetic mode which has more than 90% of its energy confined in an area smaller than 5 microns by 5 microns and that comprises a second-order nonlinearity configured to or operable to (e.g., by dispersion engineering and quasi phase matching) modify (or capable of modifying) at least one of the spectrum or the temporal shape of the input pulses, which involves (or the modifying comprises) generation of new spectral content to form/output output pulses 106 from the input pulses 102; and
   one or multiple outputs 108 of the chip outputting the output pulses in response to the input pulses which are shorter than 1 nanosecond and longer than 3 femtoseconds (fs) (or shorter than input pulse in the range of few cycles/3fs to less than 1 ns) at their full width at half maximum and
   wherein the output pulses have different spectral and/or temporal shapes than the input pulses; and
   wherein the input coupler further comprises at least one of a mode converter, waveguide taper 304, inverse waveguide taper, or a mode filter 306 configured for (e.g., efficiently) routing the radiation in one or a plurality of the modes of the first waveguide to one or a plurality of modes in the second waveguide.
2. The chip of clause 1, wherein at least the second waveguide comprises quasi-phase matching, for instance using periodic poling with a single, multiple, or chirped poling periods, for one or a plurality of efficient nonlinear processes using the second order nonlinearity, e.g., the one or more nonlinear processes comprising, for instance, at least one of second-harmonic generation, intra-pulse difference-frequency generation (IDFG), intra-pulse sum-frequency generation (ISFG), supercontinuum generation (SCG), optical parametric amplification (OPA) or optical parametric generation (OPG) using the same input or an additional input for a pump, difference frequency generation involving an additional input, or sum-frequency generation involving an additional input.
3. The chip of clause 1 or 2, where in the second waveguide is coupled to one or a plurality of resonators 120, or the second waveguide is a part of a resonator 120, and wherein the one or more resonators provide resonance for at least part of an input spectrum of the input pulse or part of the generated spectrum of the output pulses.
4. The chip of any of the clauses 1-3, wherein at least one of the first input waveguide or the second waveguide comprise multiple waveguide geometries including a varying top width W, e.g., in the range of 10 micrometers (μm) to 100 nanometers (nm) of the waveguide (e.g., 100 nm≤W≤10 micrometers) for dispersion engineering, phase matching, mode conversion, or mode filtering of the electromagnetic radiation.
5. The chip of any of the clauses 1-4, wherein the input pulses comprise an input frequency comb and the nonlinear waveguide is further configured for generating one or more beatnotes at the output associated with the carrier-envelope offset (CEO) frequency of the input frequency comb through spectral broadening of the input pulses to form a broadened spectrum and generating harmonics of the broadened spectrum and/or spectral broadening of the harmonics of the input pulses or spectrally broadened input pulses, wherein the one or more beatnotes are the result of one or a plurality of interferences between fundamental and second harmonic (f−2f), second-harmonic and third harmonic (2f−3f), third-harmonic and fourth harmonic (3f−4f), fundamental and half-harmonic (f−f/2), or similar harmonic combinations of the electromagnetic radiation in the nonlinear waveguide.
6. The chip of any of the clause 1-5 further comprising an integrated photodetector 122, for example through edge coupling, surface coupling, heterogeneous or integration, which is configured for receiving the output pulses outputted from the circuit and generating an electric signal associated with the CEO frequency of the input frequency comb.
7. The chip of any of the clauses 1-6 wherein the second waveguide is configured for spectral broadening of the input pulses, and the circuit further comprises components 124 configured to control the temporal shape of the output pulses by providing control over the phases of different spectral portions of the spectrally broadened output pulses.
8. The chip of any of the clauses 1-7 where the temporal shape of the output pulses is controlled by the circuit further comprising:
at least one second waveguide coupled to a plurality of additional waveguides 115 and a frequency-dependent splitter, wherein the frequency dependent splitter is configured to split the spectrum into two or more portions, each portion guided into a different one of the plurality of additional waveguides 115;
one or more phase actuators 125 on the additional waveguides and configured for guiding and adjusting the phase of different portions of the spectrum using electrical inputs, for instance electrooptic modulators or heaters; and/or
a frequency combiner to combine different portions of the spectrum from the additional waveguides into one or a plurality of the outputs which output the temporally synthesized output pulses.
9. The chip of any of the clauses 1-8 wherein the photonic integrated circuit comprises a tunable filter 502 before and/or after the second waveguide for selecting one or more frequency bins of the input and/or output pulses, wherein the tunable filter is tunable using one or multiple electrooptic modulators or heaters.
10. The chip of any of the clauses 1-9, wherein the circuit further comprises at least one of the nonlinear waveguides configured as an optical parametric chirped pulse amplifier (OPCPA) unit by providing proper dispersion engineering and phase-matching engineering, and wherein the circuit further comprises an additional pump input to the OPCPA and for amplification of the pulses at the output of the second waveguide.
11. The chip of any of the clauses 1-10, wherein the second waveguide is configured through dispersion engineering and quasi-phase matching to support soliton formation and propagation in the second waveguide, including both single pass and cavity solitons.
12. The chip of any of the clauses 1-11 wherein the circuit is formed on a (e.g., thin) film with (e.g., strong) second order nonlinearity, such as lithium niobate or lithium tantalate, on substrates including silicon dioxide on a silicon, silicon dioxide on bulk lithium niobate, quartz and sapphire, and wherein the nonlinear waveguide comprises periodic poling of the lithium niobate thin film.
13. A packaged unit 200 comprising the chip of any of the clauses 1-12, comprising:
a photonic integrated circuit encapsulated in a protective package 202;
at least one optical input port 204 configured to receive the input pulses 102;
at least one optical output port 206 configured to output the output pulses 106; and
thermal management component(s) 220 integrated into the package.
14. A packaged unit 200, 201 comprising the chip of any of the clauses 1-13 for analyzing a sample, including (but not limited to) one or a combination of a gas mixture, a liquid mixture, or particles, atoms, ions or molecules wherein the packaged unit comprises
a cavity for the sample and wherein the electromagnetic radiation in the photonic integrated circuit interacts with the sample through which the output pulses carry information about the composition of the sample for instance through molecular or atomic absorption and/or dispersion.
15. The packaged unit 201 of clause 14 wherein the packaged unit further comprises a photodetector 122 to generate an electric signal in response to the output pulses where the electric signal carries information about the composition of the sample, for instance through the absorption spectrum of the sample.
16. A packaged unit 200, 201 comprising a photonic integrated circuit comprising chi(2) nonlinearity configured for synthesizing pulses of electromagnetic radiation by spectrally broadening and temporally shortening pulses inputted to the circuit.
17. A packaged unit 201 comprising a source (MHLL, or laser) of electromagnetic pulses and comprising a photonic integrated circuit (e.g., of any of the clauses 1-15) comprising one or more components with a second order nonlinearity configured for synthesizing pulses by spectrally broadening and temporally shortening input pulses inputted to the circuit from the source.
18. The packaged unit of clause 17, wherein the source or a part of the source is on the same or a separate photonic integrated circuit, for instance in the form of a mode-locked laser (MLL), an electrooptic frequency comb, or a Kerr frequency comb.
19. The packaged unit of clause 18, wherein the source further comprises a semiconductor component, for instance a semiconductor optical amplifier (SOA) or a semiconductor laser.
20. The chip of any of the clauses 1-19, where in the circuit is realized in one or a combination of materials including doped and un-doped variants of LN and LT, graphene, and III-V materials such as AlN, AlGaN, GaN, GaPN, InGaN, InPN, InN, AlP, AlGaP, AlInP, GaP, AlAs, GaInP, GaAs, InP, InGaP, AlSb, GaSb, InSb, or InAs.
21. A photonic integrated circuit comprising an input coupler 99 comprising a first waveguide 110 comprising a first cross-section 112 configured or operable to (e.g., by structuring) or capable of receive/receiving input pulses 102 from a free-space beam, optical fiber, or another waveguide and a nonlinear circuit 98 comprising one or more second waveguides 114 each comprising a nonlinear waveguide with a second cross-section 116 that supports an electromagnetic mode which has more than 90% of its energy confined in an area A smaller than 5 microns by 5 microns and that comprises a second-order nonlinearity configured (e.g., by phase matching and dispersion engineering) to modify the spectrum and/or the temporal shape of the input pulses, which involves generation of new spectral content to form output pulses 106 from the input pulses 102. The circuit may comprise additional waveguides 115 and other components 124, 125 to route or split different pulses/different spectral components/different portions of the spectrum or pulses, to/between different ones of the second waveguides 114.
22. The circuit of clause 21 comprising the circuit of any of the clauses 1-20.
23. An integrated photonic chip comprising a photonic integrated circuit configured to accept input pulses of electromagnetic radiation, which are shorter than 1 ns at their full-width at half-maximum, and generates output pulses at one or multiple outputs of the chip which have different spectral and/or temporal shapes than the input pulses, and the circuit comprises the following (e.g., which configure the circuit to accept the input pulses and generate the output pulses in response thereto):
an input coupler comprising a first waveguide comprising a first cross-section to efficiently receive the input pulses from a free-space beam, optical fiber, or another waveguide;
at least one second waveguide comprising a nonlinear waveguide with a second cross-section that supports an electromagnetic mode which has more than 90% of its energy confined in an area smaller than 5 microns by 5 microns and that comprises second-order nonlinearity configured to modify the spectrum and/or the temporal shape of the input pulses, which involves generation new spectral content; and
wherein the input coupler further comprises at least one of a mode converter, waveguide taper, inverse waveguide taper, or a mode filter configured for efficiently routing the radiation in one or a plurality of the modes of the first waveguide to one or a plurality of modes in the second waveguide.
24. An integrated photonic chip comprising a photonic integrated circuit that generates output pulses at one or multiple outputs in response to input pulses which are shorter than 1 ns (e.g. longer than 3 fs), where the output pulses have different spectral and/or temporal shapes than the input pulses, and the circuit comprises:
an input coupler comprising a first waveguide comprising a first cross-section to efficiently receive the input pulses from a free-space beam, optical fiber, or another waveguide;
at least one second waveguide comprising a nonlinear waveguide with a second cross-section that supports an electromagnetic mode which has more than 90% of its energy confined in an area smaller than 5 microns by 5 microns and that comprises second-order nonlinearity configured to modify the spectrum and/or the temporal shape of the input pulses, which involves generation new spectral content; and
wherein the input coupler further comprises at least one of a mode converter, waveguide taper, inverse waveguide taper, or a mode filter configured for efficiently routing the radiation in one or a plurality of the modes of the first waveguide to one or a plurality of modes in the second waveguide.
25. The circuit of clause 23 or 24 comprising the circuit of any of the clauses 1-22.

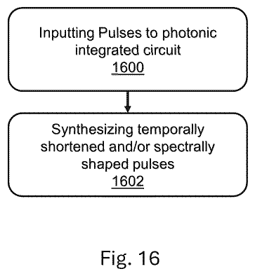

FIG. 16 illustrates a method of synthesizing pulses comprising the following steps.

Block 1600 represents inputting input pulses having a FWHM of 1 nanosecond or less into an input coupler of a photonic integrated circuit as described herein.

Block 1602 represents synthesizing output pulses from the input pulses. The method of synthesizing can use the device of any of the clauses 1-25.

### REFERENCES

The following references are incorporated by reference herein.
[1] H. Liang, P. Krogen, Z. Wang, H. Park, T. Kroh, K. Zawilski, P. Schunemann, J. Moses, L. F. DiMauro, F. X. Kartner, and K.-H. Hong, Nature Communications 8, 141 (2017)
[2] D. M. B. Lesko, H. Timmers, S. Xing, A. Kowligy, A. J. Lind, and S. A. Diddams, Nature Photonics 15, 281 (2021)
[3] U. Elu, L. Maidment, L. Vamos, F. Tani, D. Novoa, M. H. Frosz, V. Badikov, D. Badikov, V. Petrov, P. St. J. Russell, and J. Biegert, Nature Photonics 15, 277 (2021)
[4] N. Dudovich, D. Oron, and Y. Silberberg, Nature 418, 512 (2002)
[5] M. Drescher, M. Hentschel, R. Kienberger, M. Uiberacker, V. Yakovlev, A. Scrinzi, T. Westerwalbesloh, U. Kleineberg, U. Heinzmann, and F. Krausz, Nature 419, 803 (2002).
[6] T.-H. Wu, L. Ledezma, C. Fredrick, P. Sekhar, R. Sekine, Q. Guo, R. M. Briggs, A. Marandi, and S. A. Diddams, Nature Photonics 18, 218 (2024)
[7] M. Jankowski, C. Langrock, B. Desiatov, A. Marandi, C. Wang, M. Zhang, C. R. Phillips, M. Loncar, and M. M. Fejer, Optica 7, 40(2020)
[8] M. Jankowski, N. Jornod, C. Langrock, B. Desiatov, A. Marandi, M. Loncar, and M. M. Fejer, Optica 9, 273 (2022)
[9] R. Sekine, R. M. Gray, L. Ledezma, S. Zhou, Q. Guo, and A. Marandi, Multi-octave frequency comb from an ultra-lowthreshold nanophotonic parametric oscillator (2023), arXiv:2309.04545
[10] L. He, M. Zhang, A. Shams-Ansari, R. Zhu, C. Wang, and L. Marko, Opt. Lett. 44, 2314 (2019)
[11] C. Hu, A. Pan, T. Li, X. Wang, Y. Liu, S. Tao, C. Zeng, and J. Xia, Opt. Express 29, 5397 (2021).
[12] M. Bahadori, M. Nikdast, Q. Cheng, and K. Bergman, Journal of Lightwave Technology 37, 3044 (2019)
[13] L. Ledezma, R. Sekine, Q. Guo, R. Nehra, S. Jahani, and A. Marandi, Optica 9, 303 (2022)
[14] C. Manzoni, O. D. Mucke, G. Cirmi, S. Fang, J. Moses, S.-W. Huang, K.-H. Hong, G. Cerullo, and F. X. Kartner, Laser & Photonics Reviews 9, 129 (2015),
[15] H. R. Telle, G. Steinmeyer, A. E. Dunlop, J. Stenger, D. H. Sutter, and U. Keller, Applied Physics B 69, 327 (1999).
[16] D.-G. Kim, S. Han, J. Hwang, I. H. Do, D. Jeong, J.-H. Lim, Y.-H. Lee, M. Choi, Y.-H. Lee, D.-Y. Choi, and H. Lee, Nature Communications 11, 5933 (2020)
[17] R. M. Gray, M. Liu, S. Zhou, A. Roy, L. Ledezma, and A. Marandi, Quadratic-soliton-enhanced mid-ir molecular sensing (2023), arXiv:2301.07826
[18] A. Roy, L. Ledezma, L. Costa, R. Gray, R. Sekine, Q. Guo, M. Liu, R. M. Briggs, and A. Marandi, Visible-to-mid-ir tunable frequency comb in nanophotonics (2022), arXiv:2212.08723
[19] T.-H. Wu, L. Ledezma, C. Fredrick, P. Sekhar, R. Sekine, Q. Guo, R. M. Briggs, A. Marandi, and S. A. Diddams, (2023), arXiv:2305.08006
[20] E. Hwang, N. Harper, R. Sekine, L. Ledezma, A. Marandi, and S. Cushing, Opt. Lett. 48, 3917 (2023)
[21] D. M. B. Lesko, H. Timmers, S. Xing, A. Kowligy, A. J. Lind, and S. A. Diddams, Nature Photonics 15, 281 (2021).
[22] U. Elu, L. Maidment, L. Vamos, F. Tani, D. Novoa, M. H. Frosz, V. Badikov, D. Badikov, V. Petrov, P. St. J. Russell, and J. Biegert, Nature Photonics 15, 277 (2021)
[23] I. Pupeza, D. Sanchez, J. Zhang, N. Lilienfein, M. Seidel, N. Karpowicz, T. Paasch-Colberg, I. Znakovskaya, M. Pescher, W. Schweinberger, V. Pervak, E. Fill, O. Pronin, Z. Wei, F. Krausz, A. Apolonski, and J. Biegert, Nature Photonics 9, 721(2015)
[24] G. Imeshev, M. M. Fejer, A. Galvanauskas, and D. Harter, J. Opt. Soc. Am. B 18, 534 (2001)
[25] M. Wegener, Extreme Nonlinear Optics: An Introduction, Advanced Texts in Physics (Springer Berlin Heidelberg, 2006).
[26] P. B. Corkum and F. Krausz, Nature Physics 3, 381 (2007)
[27] S. Ghimire and D. A. Reis, Nature Physics 15, 10 (2019)
[28] E. Goulielmakis, M. Schultze, M. Hofstetter, V. S. Yakovlev, J. Gagnon, M. Uiberacker, A. L. Aquila, E. M. Gullikson, D. T. Attwood, R. Kienberger, F. Krausz, and U. Kleineberg, Science 320, 1614 (2008)
[29] S. Kim, J. Jin, Y.-J. Kim, I.-Y. Park, Y. Kim, and S.-W. Kim, Nature 453, 757 (2008)
[30] G. Sansone, L. Poletto, and M. Nisoli, Nature Photonics 5, 655 (2011).
[31] A. L. Cavalieri, N. Müller, T. Uphues, V. S. Yakovlev, A. Baltuska, B. Horvath, B. Schmidt, L. Blümel, R. Holzwarth, S. Hendel, M. Drescher, U. Kleineberg, P. M. Echenique, R. Kienberger, F. Krausz, and U. Heinzmann, Nature 449, 1029 (2007)
[32] D. Hui, H. Alqattan, S. Yamada, V. Pervak, K. Yabana, and M. T. Hassan, Nature Photonics 16, 33 (2022).
[33] A. Dubietis, G. Jonusauskas, and A. Piskarskas, Optics Communications 88, 437 (1992)
[34] I. Pupeza, M. Huber, M. Trubetskov, W. Schweinberger, S. A. Hussain, C. Hofer, K. Fritsch, M. Poetzlberger, L. Vamos, E. Fill, T. Amotchkina, K. V. Kepesidis, A. Apolonski, N. Karpowicz, V. Pervak, O. Pronin, F. Fleischmann, A. Azzeer, M. Zigman, and F. Krausz, Nature 577, 52 (2020)
[35] A. H. Zewail, Science 242, 1645 (1988)
[36] L. F. Mollenauer, R. H. Stolen, and J. P. Gordon, Physical review letters 45, 1095 (1980).
[37] P. Colman, C. Husko, S. Combrie, I. Sagnes, C. W. Wong, and A. De Rossi, Nature Photonics 4, 862 (2010).
[38] J. M. Dudley, G. Genty, and S. Coen, Rev. Mod. Phys. 78, 1135 (2006)
[39] B. Zhou, A. Chong, F. Wise, and M. Bache, Physical review letters 109, 043902 (2012).
[40] M. Bache, J. Moses, and F. Wise, JOSA B 24, 2752 (2007).
[41] C. Menyuk, R. Schiek, and L. Torner, JOSA B 11, 2434 (1994).
[42] M. Bache, O. Bang, J. Moses, and F. W. Wise, Optics Letters 32, 2490 (2007).
[43] Y. S. Kivshar and G. P. Agrawal, Optical solitons: from fibers to photonic crystals (Academic press, 2003).
[44] A. V. Buryak, P. Di Trapani, D. V. Skryabin, and S. Trillo, Physics Reports 370, 63 (2002).
[45] H. He, M. Werner, and P. Drummond, Physical Review E 54, 896 (1996).
[46] M. Bache, O. Bang, W. Krolikowski, J. Moses, and F. W. Wise, Optics Express 16, 3273 (2008).
[47] M. Jankowski, A. Marandi, C. Phillips, R. Hamerly, K. A. Ingold, R. L. Byer, and M. Fejer, Physical review letters 120, 053904 (2018).
[48] A. A. Sukhorukov, Physical Review E 61, 4530 (2000).
[49] A. Boardman, K. Xie, and A. Sangarpaul, Physical Review A 52, 4099 (1995).
[50] R. Sekine, R. Gray, L. Ledezma, Q. Guo, and A. Marandi, in Conference on Lasers and Electro-Optics (Optica Publishing Group, 2022) p. SM5K.2.
[51] A. Roy, R. Nehra, S. Jahani, L. Ledezma, C. Langrock, M. Fejer, and A. Marandi, Nature Photonics 16, 162 (2022)
[52] K. Goda and B. Jalali, Nature Photonics 7, 102 (2013).
[53] B. H. Kolner and M. Nazarathy, Optics letters 14, 630 (1989).

### Additional Information on Soliton Pulse Compression

Ultrashort pulses are crucial for myriad applications, ranging from fundamental studies of electronic motion in atoms and molecules [1,2] to extreme nonlinear optics

. Synthesis of ultrashort pulses is generally done in two stages. Firstly, one must produce an ultrabroadband coherent spectrum, typically via supercontinuum generation. Secondly, dispersive optics are used to compress the pulse in time [5]. This results in a large system complexity for generation of few- and single-cycle pulses. One path towards circumventing these requirements is to use soliton pulse compression, where the nonlinear phase accumulated due to self-phase modulation (SPM) in the spectral broadening process is directly compensated by the dispersion of the mediating material [6-8]. As the SPM arising from the third-order nonlinearity results in normal dispersion, a material with anomalous dispersion is required. Additionally, careful design of the dispersion, pump energy, and propagation length is necessary to avoid soliton fission and other nonlinear effects which can distort the temporal shape of the pulse, limiting the achievable pulse widths in such systems without an additional compression stage [9].

In addition to cubic nonlinear media, supercontinuum generation has been achieved through spectral broadening from phase-mismatched nonlinear interactions in quadratic nonlinear media [10]. Soliton pulse compression in such phase-mismatched second-harmonic generation (SHG) has also been observed down to the few-cycle regime and has the additional advantage of being achievable for both anomalous and normal dispersion [11,12]. However, bulk nonlinear optical crystals have inflexible dispersion profiles and thus face fundamental limitations in their potential for achieving arbitrary pulse compression due to the effects of group-velocity mismatch (GVM) between the fundamental and second harmonic as well as higher-order dispersion [13]. More recently, progress in lithium niobate (LN) nanophotonics has facilitated generation of multi-octave coherent supercontinuum leveraging phasemismatched SHG [14] as well as optical parametic oscillation (OPO) [15] while requiring modest pump pulse energies in the pJ and fJ range, respectively. Here, we show that the dispersion engineering capabilities afforded by the nanophotonic platform can enable soliton pulse compression in such phase-mismatched nonlinear interactions, offering a flexible pathway towards on-chip generation of few- and even single-cycle pulses.

The on-chip pulse compression scheme is illustrated in FIG. 1a. Pulses at the fundamental are coupled into the slightly quasi-phase-mismatched waveguide on the nanophotonic chip, and phase-mismatched interaction with the generated second harmonic results in large pulse compression over the course of propagation. In our experiment, 35-fs pulses at the fundamental wavelength, 2090 nm, are generated in a free space optical parametric oscillator (OPO) pumped by a Yb-fiber mode locked laser (MLL) and coupled into the chip via a reflective objective. Experimental characterization of the input and output pulses is done using a home-built frequency-resolve optical gating (FROG) setup based on non-collinear SHG and sum-frequency generation (SFG) in a 50-μm BBO crystal [16]. Our chip consists of x-cut, 700-nm thin-film LN on a SiO₂ buffer layer. The designed waveguide has a width of 2500 nm and an etch depth of 250 nm, resulting in a group velocity dispersion of 62.7 fs²/mm at 2090 nm and 138 fs²/mm at 1045 nm as well as a GVM of 35.5 fs/mm. A 5-mm periodically poled region facilitates the phase-mismatched second harmonic generation in the waveguide [17].

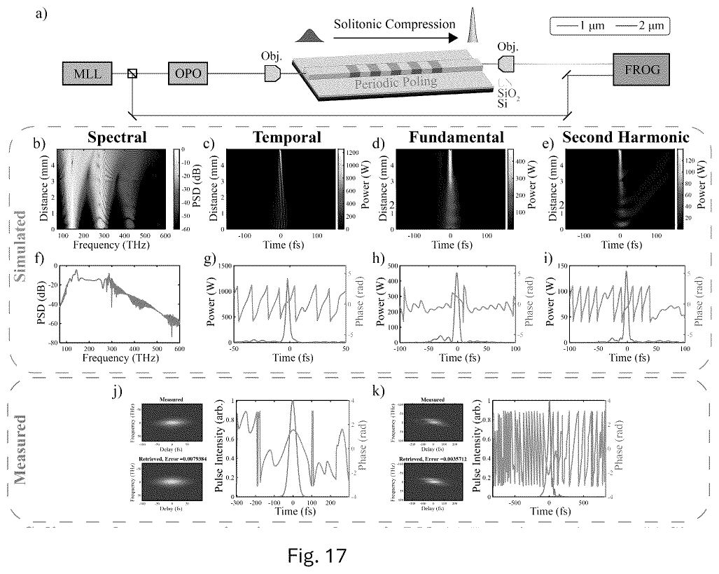

FIGS. 17b-i show the simulated soliton pulse compression in the fabricated device. Our simulations utilize a single-envelope equation to model the pulse evolution inside the waveguide [18]. Here, we consider a pump pulse energy of 7 pJ and a poling period of 5.598 μm, 40 nm larger than the calculated phase-matched period of 5.558 μm, parameters which are readily realizable experimentally. As can be seen in FIGS. 17b and 17f, the spectrum around both the fundamental at 143 THz and the second harmonic at 286 THz is seen to rapidly broaden, resulting in multi-octave supercontinuum generation. In the time domain (FIGS. 1c-e), we see that the balance of dispersion and nonlinear phase as well as walk-off and nonlinear acceleration facilitates localization and compression for both the fundamental and second harmonic over the course of their propagation. The resulting pulses (FIGS. g-i) have widths as small as 7 fs for the fundamental and second harmonic as well as 3.5 fs for their combined output, suggesting soliton pulse compression to the single-cycle regime is possible.

Our experimental results are shown in FIGS. 17j-k. FIG. 17j shows our SHG FROG characterization of the 35 fs pulses at 2090 nm output by the free-space OPO. With a Fourier grid size of 512, the algorithm converges with a retrieved error of 0.008, giving a chirped 44-fs pulse. This result is in good agreement with our expected pulse shape, as the 35-fs OPO output traverses several optical elements including a neutral-density and long-pass filter before entering the FROG setup. Besides pumping the OPO, a portion of the MLL output is also used to gate the weaker off-chip signal in an X-FROG geometry. FIG. 17k illustrates a typical measured pulse out of the nanophotonic chip; here, specifically, the second harmonic output is measured. While the transform-limited pulse width is seen to narrow, consistent with the expected spectral broadening from supercontinuum generation, compression to the few- or even single-cycle regime is yet to be observed, with the measured pulses exhibiting similar pulse widths to the input. Better compression is expected through improved dispersion management in the measurement setup and better thermal stabilization of the chip for precise phase matching and tuning.

### REFERENCES (INCORPORATED BY REFERENCE HEREIN)

P. B. Corkum and F. Krausz, Nat. Phys. 3, 381-387 (2007).
D. Hui et al., Nat. Photonics 16, 33-37 (2022).
M. Wegener (Springer, 2005).
E. Goulielmakis et al., Science 320, 1614-1617 (2008).
C. Manzoni et al., Laser & Photonics Rev. 9, 129-171 (2015).
L. F. Mollenauer et al., Phys. Rev. Lett. 45, 1095-1098 (1980).
G. A. Nowak et al., Appl. Opt. 38, 7364-7369 (1999).
P. Colman et al., Nat. Photonics 4, 862-868 (2010).
J. M. Dudley et al., Rev. Mod. Phys. 78, 1135 (2006).
C. R. Phillips et al., Opt. Express 19, 18754-18773 (2011).
M. Bache et al., Opt. Lett. 32, 2490-2492 (2007).
B. Zhou et al., Phys. Rev. Lett. 109, 043902 (2012).
M. Bache et al., Opt. Express 16, 3273-3287 (2008).
M. Jankowski et al., APL Photonics 8, 116104 (2023).
R. Sekine et al., arXiv preprint arXiv: 2309.04545 (2023).
R. Trebino (Springer, 2000).
L. Ledezma et al., Sci. Adv. 9, eadf9711 (2023).
L. Ledezma et al., Optica 9, 303-308 (2022).

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An integrated photonic chip comprising a photonic integrated circuit comprising:
an input coupler comprising a first waveguide comprising a first cross-section to receive input pulses from a free-space beam, optical fiber, or another waveguide;
at least one second waveguide comprising a nonlinear waveguide with a second cross-section that supports an electromagnetic mode which has more than 90% of its energy confined in an area smaller than 5 microns by 5 microns and that comprises a second-order nonlinearity configured to modify the spectrum and/or the temporal shape of the input pulses, which involves generation of new spectral content to output pulses from the input pulses; and
one or multiple outputs of the chip outputting the output pulses in response to the input pulses which are shorter than 1 nanosecond and longer than 3 fs at their full width at half maximum and
wherein the output pulses have different spectral and/or temporal shapes than the input pulses; and
wherein the input coupler further comprises at least one of a mode converter, waveguide taper, inverse waveguide taper, or a mode filter configured for efficiently routing the radiation in one or a plurality of the modes of the first waveguide to one or a plurality of modes in the second waveguide.

2. The chip of claim 1, wherein at least the second waveguide comprises quasi-phase matching for one or a plurality of efficient nonlinear processes using the second order nonlinearity, the nonlinear process comprising at least one of second-harmonic generation, intra-pulse difference-frequency generation (IDFG), intra-pulse sum-frequency generation (ISFG), supercontinuum generation (SCG), optical parametric amplification (OPA) or optical parametric generation (OPG) using the same input or an additional input for a pump, difference frequency generation involving an additional input, or sum-frequency generation involving an additional input.

3. The chip of claim 1, where in the second waveguide is coupled to one or a plurality of resonators, or the second waveguide is a part of a resonator, and wherein the one or more resonators provide resonance for at least part of an input spectrum of the input pulse or part of the generated spectrum of the output pulses.

4. The chip of claim 1, wherein at least one of the first input waveguide or the second waveguide comprise multiple waveguide geometries including a varying top width W in the range of 10 μm to 100 nm of the waveguide for dispersion engineering, phase matching, mode conversion, or mode filtering of the electromagnetic radiation.

5. The chip of claim 1, wherein the input pulses comprise an input frequency comb and the nonlinear waveguide is further configured for generating one or more beatnotes at the output associated with the carrier-envelope offset (CEO) frequency of the input frequency comb through spectral broadening of the input pulses to form a broadened spectrum and generating harmonics of the broadened spectrum and/or spectral broadening of the harmonics of the input pulses or spectrally broadened input pulses, wherein the one or more beatnotes are the result of one or a plurality of interferences between fundamental and second harmonic (f−2f), second-harmonic and third harmonic (2f−3f), third-harmonic and fourth harmonic (3f−4f), fundamental and half-harmonic (f−f/2), or similar harmonic combinations of the electromagnetic radiation in the nonlinear waveguide.

6. The chip of claim 5 further comprising an integrated photodetector integrated through edge coupling, surface coupling, or heterogeneous integration, wherein the photodetector is configured for receiving the output pulses outputted from the circuit and generating an electric signal associated with the CEO frequency of the input frequency comb.

7. The chip of claim 1 wherein the second waveguide is configured for spectral broadening of the input pulses, and the circuit further comprises components configured to control the temporal shape of the output pulses by providing control over the phases of different spectral portions of the spectrally broadened output pulses.

8. The chip of claim 7 where the temporal shape of the output pulses is controlled by the circuit further comprising:
at least one second waveguide coupled to a plurality of additional waveguides and a frequency-dependent splitter, wherein the frequency dependent splitter is configured to split the spectrum into two or more portions, each portion guided into a different one of the plurality of additional waveguides;
phase actuators on the additional waveguides and configured for guiding and adjusting the phase of different portions of the spectrum using electrical inputs, wherein the phase actuators comprise electrooptic modulators or heaters; and/or
a frequency combiner to combine different portions of the spectrum from the additional waveguides into one or a plurality of the outputs which output the temporally synthesized output pulses.

9. The chip of claim 1 wherein the photonic integrated circuit comprises a tunable filter before and/or after the second waveguide for selecting one or more frequency bins of the input and/or output pulses, wherein the tunable filter is tunable using one or multiple electrooptic modulators or heaters.

10. The chip of claim 1, wherein the circuit further comprises at least one of the nonlinear waveguides configured as an optical parametric chirped pulse amplifier (OPCPA) unit by providing proper dispersion engineering and phase-matching engineering, and wherein the circuit further comprises an additional pump input to the OPCPA and for amplification of the pulses at the output of the second waveguide.

11. The chip of claim 1, wherein the second waveguide is configured through dispersion engineering and quasi-phase matching to support soliton formation and propagation in the second waveguide, including both single pass and cavity solitons.

12. The chip of claim 1 wherein the circuit is formed on a film with second order nonlinearity on substrates including silicon dioxide on a silicon, silicon dioxide on bulk lithium niobate, quartz and sapphire, and wherein the nonlinear waveguide comprises periodic poling of the lithium niobate thin film.

13. A packaged unit comprising the chip of claim 1, comprising:
a photonic integrated circuit encapsulated in a protective package;
at least one optical input port configured to receive the input pulses;
at least one optical output port configured to output the output pulses; and
thermal management components integrated into the package.

14. A packaged unit comprising the chip of claim 1 for analyzing a sample, including one or a combination of a gas mixture, a liquid mixture, or particles, wherein the packaged unit comprises
a cavity for the sample and wherein the electromagnetic radiation in the photonic integrated circuit interacts with the sample through which the output pulses carry information about the composition of the sample for instance through molecular or atomic absorption and/or dispersion.

15. The packaged unit of claim 14 wherein the packaged unit further comprises a photodetector to generate an electric signal in response to the output pulses where the electric signal carries information about the composition of the sample through the absorption spectrum of the sample.

16. A packaged unit comprising a photonic integrated circuit comprising chi(2) nonlinearity configured for synthesizing pulses of electromagnetic radiation by spectrally broadening and temporally shortening pulses inputted to the circuit.

17. A packaged unit comprising a source of electromagnetic pulses comprising a photonic integrated circuit comprising one or more components with a second order nonlinearity configured for synthesizing pulses by spectrally broadening and temporally shortening input pulses inputted to the circuit from the source.

18. The packaged unit of claim 17, wherein the source or a part of the source is on the same or a separate photonic integrated circuit and comprises at least one of a mode-locked laser, an electrooptic frequency comb, or a Kerr frequency comb.

19. The packaged unit of claim 18, wherein the source further comprises a semiconductor component comprising a semiconductor optical amplifier (SOA) or a semiconductor laser.

20. The chip of claim 1, where in the circuit is realized in one or a combination of materials including at least one of doped or un-doped variants of LN and LT, graphene, or at least one III-V material selected from AlN, AlGaN, GaN, GaPN, InGaN, InPN, InN, AlP, AlGaP, AlInP, GaP, AlAs, GaInP, GaAs, InP, InGaP, AlSb, GaSb, InSb, or InAs.
